(19) United States
(12) Patent Application Publication
(10) Pub. No.: US 2023/0118005 A1
(43) Pub. Date: Apr. 20, 2023

(54) ELECTROCHEMICALLY DEBONDABLE ADHESIVE COMPOSITION

(71) Applicant: Henkel AG & Co. KGaA, Duesseldorf (DE)

(72) Inventors: Kang Wei Chou, Cerdanyola del Valles (ES); Daniel Peral Crespo, Barcelona (ES); Clara Anduix Cantó, Barcelona (ES); Anna Maria Díaz Rovira, Barcelona (ES); Alejandro Belmez Lledo, Barcelona (ES); Víctor Pérez Padilla, Berlin (DE)

(21) Appl. No.: 18/078,152

(22) Filed: Dec. 9, 2022

Related U.S. Application Data
(63) Continuation of application No. PCT/EP2021/064562, filed on May 31, 2021.

(30) Foreign Application Priority Data
Jun. 22, 2020 (EP) 20382539.3

(51) Int. Cl. B08B 7/00; C09J 7/10; C09J 11/04; C09J 11/08; C09J 179/04; C09J 5/06

(52) U.S. Cl. CPC B08B 7/00; C09J 7/10; C09J 11/04; C09J 11/08; C09J 179/04; C09J 5/06; C09J 2301/408; C09J 2301/502

(57) ABSTRACT

The present invention is directed to a curable and electrochemically debondable adhesive composition comprising, based on the weight of the composition:
from 40 to 99 wt. % of a) at least one ethylenically unsaturated non-ionic monomer;
from 0.9 to 50 wt. % of b) at least one polymerizable ionic compound, wherein said polymerizable ionic compound comprises:
   b1) at least one compound in accordance with general formula IV; and/or
   b2) at least one compound in accordance with general formula V; and, from 0.1 to 10 wt. % of c) at least one free radical initiator.

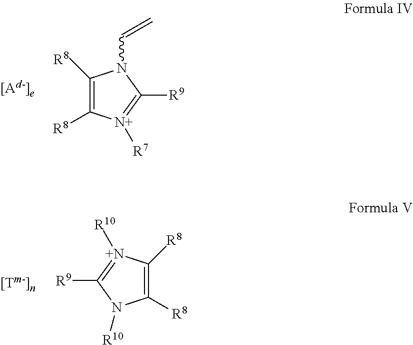

### FIELD OF THE INVENTION

The present invention is directed to a curable adhesive composition which can be debonded from particular substrates to which it is applied. More particularly, the present invention is directed to a curable and electrochemically debondable adhesive composition which comprises a polymerizable electrolyte.

### BACKGROUND TO THE INVENTION

Adhesive bonds and polymeric coatings are commonly used in the assembly and finishing of manufactured goods. They are used in place of mechanical fasteners, such as screws, bolts and rivets, to provide bonds with reduced machining costs and greater adaptability in the manufacturing process. Adhesive bonds distribute stresses evenly, reduce the possibility of fatigue and seal the joints from corrosive species.

Whilst adhesive bonds offer many advantages over mechanical fasteners, it tends to be difficult to disassemble adhesively bonded objects where this is required in practical applications, for example in the recycling of adhered primary materials. The removal of the adhesive through mechanical processes—such as by sand blasting or by wire brushing—is often precluded, in part because the adhesive is disposed between substrates and is thus either inaccessible or difficult to abrade without corrupting the substrate surfaces. Disassembly through the application of chemicals and/or high temperature—such as disclosed in U.S. Pat. No. 4,171,240 (Wong) and U.S. Pat. No. 4,729,797 (Linde et al.)—might be effective but can be time consuming and complex to perform: moreover, the aggressive chemicals and/or harsh conditions required can damage the substrates being separated, rendering them unsuitable for subsequent applications.

Noting these problems, certain authors have sought to develop electrochemically debondable adhesive compositions, wherein the passage of an electrical current through the cured compositions acts to disrupt the bonding at the interface of the adhesive and the substrate.

US 2007/0269659 (Gilbert) describes an adhesive composition disbondable at two interfaces, the composition: (i) comprising a polymer and an electrolyte; (ii) facilitating joinder of two surfaces; and, (iii) in response to a voltage applied across both surfaces so as to form an anodic interface and a cathodic interface, disbonding from both the anodic and cathodic surfaces.

US 2008/0196828 (Gilbert) describes a hot-melt adhesive composition comprising: a thermoplastic component; and, an electrolyte, wherein the electrolyte provides sufficient ionic conductivity to the composition to enable a faradaic reaction at a bond formed between the composition and an electrically conductive surface and to allow the composition to disbond from the surface.

WO2007/142600 (Stora Enso AB) describes an electrochemically weakable adhesive composition which provides an adhesive bond to an electrically conducting surface and sufficient ion conductive properties to enable a weakening of said adhesive bond at the application of a voltage across the adhesive composition, wherein said composition comprises at least one ionic compound in an effective amount to give said ion conductive properties and wherein said ionic compound has a melting point of no more than 120° C.

EP 3363875 A (Nitto Denko Corporation) provides an electrically peelable adhesive composition that forms an adhesive layer which has high adhesion and can be easily peeled off upon application of a voltage for a short time. The electrically peelable adhesive composition of the invention includes a polymer and from 0.5 to 30 wt. %, based on the weight of the polymer, of an ionic liquid, wherein the anion of the ionic liquid is a bis(fluorosulfonyl)imide anion.

WO2013/135677 (Henkel AG & Co. KGaA) describes a hot melt adhesive containing: from 20 to 90 wt % of at least one polyamide having a molecular weight (Mw) from 10,000 to 250,000 g/mol; from 1 to 25 wt % of at least one organic or inorganic salt; and, from 0 to 60 wt % of further additives, wherein the adhesive has a softening point from 100° C. to 220° C.

WO2016/135341 (Henkel AG & Co. KGaA) describes a reactive hot melt adhesive composition which at least partially loses its adhesive strength upon application of an electric voltage and thus allows debonding of substrates that have been bonded using said adhesive. More particularly, the reactive hot melt adhesive composition comprises: a) at least one isocyanate-functional polyurethane polymer; and, b) at least one organic or inorganic salt.

WO2017/133864 (Henkel AG & Co. KGaA) describes a method for reversibly bonding a first and a second substrate, wherein at least the first substrate is an electrically non-conductive substrate, the method comprising: a) coating the surface of the electrically non-conductive substrate(s) with a conductive ink; b) applying an electrically debondable hot melt adhesive composition to the conductive ink-coated surface of the first substrate and/or the second substrate; c) contacting the first and the second substrates such that the electrically debondable hot melt adhesive composition is interposed between the two substrates; d) allowing formation of an adhesive bond between the two substrates to provide bonded substrates; and, e) applying a voltage to the bonded substrates whereby adhesion on at least one interface between the electrically debondable hot melt adhesive composition and a substrate surface is substantially weakened.

Where ionic liquids or electrolytes have been included in adhesive compositions, the compatibility of the electrolyte with the polymer matrix can be difficult to attain. Leakage and phase separation of the electrolyte from the cured polymer matrix have been identified as drawbacks in the applications of electrically debondable adhesives in the known art.

There remains a need in the art to provide an adhesive composition which can be conveniently applied to the surfaces of substrates to be bonded, which upon curing thereof can provide an effective bond within composite structures containing said substrates but which can be effectively de-bonded from those substrates by the facile application of an electrical potential across the cured adhesive. The cured adhesive should moreover provide a stable polymer matrix from which leakage of components is minimized and within which phase separation does not occur.

### STATEMENT OF THE INVENTION

In accordance with a first aspect of the invention there is provided a curable and electrochemically debondable adhesive composition comprising, based on the weight of the composition:

from 40 to 99 wt. %, preferably from 45 to 90 wt. % of a) at least one ethylenically unsaturated non-ionic monomer;

from 0.9 to 50 wt. %, preferably from 5 to 30 wt. % of b) at least one polymerizable ionic compound, wherein said polymerizable ionic compound comprises:

b1) at least one compound in accordance with general formula IV:

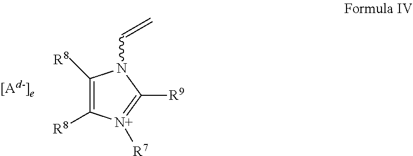

and/or

b2) at least one compound in accordance with general formula V:

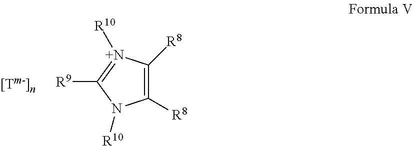

wherein: R⁷ is selected from: C₁-C₃₀ alkyl; C₂-C₈ alkenyl; C₁-C₃₀ heteroalkyl; C₃-C₃₀ cycloalkyl; C₆-C₁₈ aryl; C₁-C₉ heteroaryl; C₇-C₁₈ alkylaryl; C₂-C₅ heterocycloalkyl; or, —R^{a}—C(═O)—R^{b} where R^{a} is a C₁-C₆ alkylene group and R^{b} is a C₁-C₆ alkyl group;

each R⁸ is independently selected from H, C₁-C₁₈ alkyl, C₁-C₁₈ heteroalkyl; C₃-C₁₈ cycloalkyl, C₆-C₁₈ aryl, C₁-C₉ heteroaryl, C₇-C₁₈ alkylaryl; or, C₂-C₅ heterocycloalkyl;

R⁹ is H or C₁-C₄ alkyl;

each R¹⁰ is independently selected from: C₁-C₃₀ alkyl; C₁-C₃₀ heteroalkyl; C₃-C₃₀ cycloalkyl; C₆-C₁₈ aryl; C₁-C₉ heteroaryl; C₇-C₁₈ alkylaryl; C₂-C₅ heterocycloalkyl; or, —R^{a}—C(═O)—R^{b} where R^{a} is a C₁-C₆ alkylene group and R^{b} is a C₁-C₆ alkyl group;

A is a non-polymerizable anion;

T is an ethylenically unsaturated anion;

d and m are each integers having a value of at least 1;

e and n have a numeric value such that the compound is electrically neutral; and,

[symbol] is a covalent bond, C₁-C₂ alkylene, —CH₂OC(═O)—, —CH₂CH₂OC(═O)—, p-benzyl or p-tolyl; and,

from 0.1 to 10 wt. %, preferably from 0.1 to 5 wt. % of c) at least one free radical initiator.

The adhesive composition may be formulated as a one component (1K), two component (2K) or multi-component composition. A preference may be noted for part b) consisting of said compounds according to part b1) and/or part b2).

In an embodiment of the composition, part a) thereof comprises from 40 to 95 wt. %, preferably from 45 to 90 wt. %, based on the weight of the composition, of a1) at least one (meth)acrylate monomer represented by Formula I:

H₂C=CGCO₂R¹ (1)

wherein: G is hydrogen, halogen or a C₁-C₄ alkyl group; and,

R¹ is selected from C₁-C₃₀ alkyl, C₂-C₃₀ heteroalkyl, C₃-C₃₀ cycloalkyl; C₂-C₈ heterocycloalkyl; C₂-C₂₀ alkenyl, and, C₂-C₁₂ alkynyl.

Part a) of the composition may be further characterized by comprising from 0 to 30 wt. %, for example from 0 to 15 wt. %, based on the weight of the composition, of a2) at least one (meth)acrylate monomer represented by Formula II:

H₂C=CQCO₂R² (II)

wherein: Q may be hydrogen, halogen or a C₁-C₄ alkyl group; and,

R² may be selected from C₆-C₁₈ aryl, C₁-C₉ heteroaryl, C₇-C₁₈ alkaryl and C₇-C₁₈ aralkyl.

In a further embodiment of the composition, which is not intended to be mutually exclusive of those embodiments given above, part a) thereof comprises from 0 to 50 wt. %, preferably from 5 to 25 wt. %, based on the weight of the composition, of a3) at least one (meth)acrylate-functionalized oligomer.

Having regard to the electrolyte b) of the curable and electrochemically debondable composition, the ionic compounds according to Formulae IV and V as defined above and as detailed herein below both contain a functional group which is reactive towards radical polymerization, preferably a vinylic, allylic or acrylic functionality. The polymerizable electrolyte should thereby polymerize with any of the previously described monomers a).

As regards, compounds of Formula IV (b1), the cations are based on imidazolium rings and, upon completion of the selected curing profile, become covalently bonded to the adhesive matrix: the counter-anion (A) is free to move within the polymer matrix. Conversely, as regards compounds of Formula V (b2), the anions of the polymerizable electrolytes become covalently bonded to the adhesive matrix upon curing and the cation based on imidazolium rings is free to move in the matrix.

Preferred compounds b1), which may be present alone or in combination, include but are not limited to: 1H-Imidazolium, 3-ethenyl-1-methyl-, iodide; 1H-Imidazolium, 3-ethenyl-1-methyl-, chloride; 1H-Imidazolium, 3-ethenyl-1-methyl-, bromide; 1H-Imidazolium, 3-ethenyl-1-methyl-, methanesulfonate; 1H-Imidazolium, 3-ethenyl-1-methyl-, 1,1,1-trifluoro-N-[(trifluoromethyl)sulfonyl]methanesulfonamide; 1H-Imidazolium, 3-ethenyl-1-ethyl-, 1,1,1-trifluoro-N-[(trifluoromethyl)sulfonyl]methanesulfonamide; 1H-Imidazolium, 3-ethenyl-1-methyl-, hexafluorophosphate; 1H-Imidazolium, 3-ethenyl-1-methyl-, 4-methylbenzenesulfonate; 1H-Imidazolium, 3-ethenyl-1-methyl-, tetrafluoroborate; 1H-Imidazolium, 3-ethenyl-1-ethyl-, iodide; 1H-Imidazolium, 3-ethenyl-1-ethyl-, bromide; 1H-Imidazolium, 3-ethenyl-1-ethyl-, 1,1,1-trifluoro-N-[(trifluoromethyl)sulfonyl]methanesulfonamide; 1H-Imidazolium, 3-ethenyl-1-ethyl-, hexafluorophosphate; 1H-Imidazolium, 3-ethenyl-1-ethyl-, tetrafluoroborate; 1H-Imidazolium, 3-ethenyl-1-(1-methylethyl)-, bromide; 1H-Imidazolium, 3-(1,1-dimethylethyl)-1-ethenyl-, bromide; 1H-Imidazolium, 3-ethenyl-1-propyl-, bromide; 1H-Imidazolium, 3-ethenyl-1-(phenylmethyl)-, bromide; 1H-Imidazolium, 1-ethenyl-3-(4-methylphenyl)-, chloride; 1H-Imidazolium, 3-ethenyl-1-(1-methylpropyl)-, chloride; 1H-Imidazolium, 1-butyl-3-ethenyl-, bromide; 3-[(4-ethenylphenyl)methyl]-1-methyl-, iodide; 1H-Imidazolium, 3-[(4-ethenylphenyl)methyl]-1-methyl-, chloride; 1H-Imidazolium, 3-[(4-ethenylphenyl)methyl]-1-methyl-, 1,1,1-trifluoro-N-[(trifluoromethyl)sulfonyl]methanesulfonamide; 1H-Imidazolium, 3-[(4-ethenylphenyl)methyl]-1-methyl-, hexafluorophosphate; 1H-Imidazolium, 3-[(4-ethenylphenyl)methyl]-1-methyl-, tetrafluoroborate; 1H-Imidazolium, 3-[(4-ethenylphenyl)methyl]-1-ethyl-, chloride; 1H-Imidazolium, 1-[(4-ethenylphenyl)methyl]-3-ethyl-, salt with 1,1,1-trifluoro-N-[(trifluoromethyl)sulfonyl]methanesulfonamide; 1H-Imidazolium, 1-(3-aminopropyl)-3-[(4-ethenylphenyl)methyl]-, chloride; 1H-Imidazolium, 1-butyl-3-[(4-ethenylphenyl)methyl]-, chloride.

Preferred compounds b2), which may be present alone or in combination, include but are not limited to: 1H-Imidazolium, 1-methyl-3-hexyl-, 4-ethenylbenzenesulfonate; 1H-Imidazolium, 1-dodecyl-3-ethenyl-, 4-ethenylbenzenesulfonate; 1H-Imidazolium, 1-methyl-3-propyl-, 4-ethenylbenzenesulfonate; and, 1H-Imidazolium, 3-ethyl-1-methyl-, 4-(1-methylethenyl)benzenesulfonate.

In particular, good results have been obtained where part b) of the composition comprises or consists of at least one compound selected from the group consisting of: 1H-Imidazolium, 3-methyl-1-hexyl-4-ethenylbenzenesulfonate; 1H-Imidazolium, 3-ethenyl-1-ethyl-1,1,1-trifluoro-N-[(trifluoromethyl)sulfonyl]methanesulfonamide; and, 1H-Imidazolium, 3-methyl-1-butyl-1,1,1-trifluoro-N-[(trifluoromethyl)sulfonyl]methanesulfonamide.

In accordance with a second aspect of the invention, there is provided a bonded structure comprising:

a first material layer having an electrically conductive surface; and,

a second material layer having an electrically conductive surface, wherein the cured electrochemically debondable adhesive composition as defined hereinabove and in the appended claims is disposed between said first and second material layers.

In accordance with a third aspect of the present invention, there is provided a method of debonding said bonded structure as defined hereinabove and in the appended claims, the method comprising the steps of:

i) applying a voltage across both surfaces to form an anodic interface and a cathodic interface; and,

ii) debonding the surfaces.

Step i) of this method is preferably characterized by at least one of:

a) an applied voltage of from 1 to 100 V; and,

b) the voltage being applied for a duration of from 1 second to 180 minutes.

The adhesive property of the composition is disrupted by the application of an electrical potential across the bondline between that composition and the conductive surfaces. Without intention to be bound by theory, it is considered that the faradaic reactions which take place at the interface between the adhesive composition and the conductive surfaces disrupt the interaction between the adhesive and the substrate, thereby weakening the bond therebetween. That interfacial disruption may be the consequence of one or more processes, for instance chemical degradation of the debondable material, gas evolution at the interface and/or material embrittlement through changes to the crosslink density of the adhesive composition.

### Definitions

As used herein, the singular forms “a”, “an” and “the” include plural referents unless the context clearly dictates otherwise.

The terms “comprising”, “comprises” and “comprised of” as used herein are synonymous with “including”, “includes”, “containing” or “contains”, and are inclusive or open-ended and do not exclude additional, non-recited members, elements or method steps.

As used herein, the term “consisting of” excludes any element, ingredient, member or method step not specified.

When amounts, concentrations, dimensions and other parameters are expressed in the form of a range, a preferable range, an upper limit value, a lower limit value or preferable upper and limit values, it should be understood that any ranges obtainable by combining any upper limit or preferable value with any lower limit or preferable value are also specifically disclosed, irrespective of whether the obtained ranges are clearly mentioned in the context.

Further, in accordance with standard understanding, a weight range represented as being “from 0 to x” specifically includes 0 wt. %: the ingredient defined by said range may be absent from the composition or may be present in the composition in an amount up to x wt. %.

The words “preferred”, “preferably”, “desirably” and “particularly” are used frequently herein to refer to embodiments of the disclosure that may afford particular benefits, under certain circumstances. However, the recitation of one or more preferable, preferred, desirable or particular embodiments does not imply that other embodiments are not useful and is not intended to exclude those other embodiments from the scope of the disclosure.

As used throughout this application, the word “may” is used in a permissive sense—that is meaning to have the potential to—rather than in the mandatory sense.

As used herein, room temperature is 23° C. plus or minus 2° C. As used herein, “ambient conditions” means the temperature and pressure of the surroundings in which the composition is located or in which a coating layer or the substrate of said coating layer is located.

“Two-component (2K) compositions” in the context of the present invention are understood to be compositions in which a first component (1) and a second component (2) must be stored in separate vessels because of their (high) reactivity. The two parts are mixed only shortly before application and then react, typically without additional activation, with bond formation and thereby formation of a polymeric network. Herein higher temperatures may be applied in order to accelerate the cross-linking reaction.

As used herein the term “electrochemically debondable” means that, after curing of the adhesive, the bond strength can be weakened by at least 50% upon application of an electrical potential of 50V for a duration of 60 minutes. The cured adhesive is applied between two substrates which are bonded by said adhesive so that an electric current is running through the adhesive bond line. Bond strength is measured by Tensile Lap Shear (TLS) test performed at room temperature and based upon ASTM D3163-01 Standard Test Method for Determining Strength of Adhesively Bonded Rigid Plastic Lap-Shear Joints in Shear by Tension Loading. The bond overlapping area was 2.5 cm×1.0 cm (1″×0.4″) with a bond thickness of 0.1 cm (40 mil).

The term “electrolyte” is used herein in accordance with its standard meaning in the art as a substance containing free ions which can conduct electricity by displacement of charged carrier species. The term is intended to encompass molten electrolytes, liquid electrolytes, semi-solid electrolytes and solid electrolytes wherein at least one of the cationic or anionic components of their electrolyte structure is essentially free for displacement, thus acting as charge carrier.

The curable adhesive compositions of the present invention and the cured adhesives obtained therefrom possess “electrolyte functionality” in that the adhesive material permits the conduction of ions, either anions, cations or both.

The electrolyte functionality is understood to derive from the ability of the compositions and cured adhesives to solvate ions of at least one polarity.

The term “faradaic reaction” means an electrochemical reaction in which a material is oxidized or reduced.

As used herein, the term “monomer” refers to a substance that can undergo a polymerization reaction to contribute constitutional units to the chemical structure of a polymer. The term “monofunctional”, as used herein, refers to the possession of one polymerizable moiety. The term “polyfunctional”, as used herein, refers to the possession of more than one polymerizable moiety.

The term “ethylenically unsaturated monomer” as used herein, refers to any monomer containing a terminal double bond capable of polymerization under normal conditions of free-radical addition polymerization.

As used herein, the term “equivalent (eq.”) relates, as is usual in chemical notation, to the relative number of reactive groups present in the reaction.

As used herein, “(meth)acryl” is a shorthand term referring to “acryl” and/or “methacryl”. Thus the term “(meth)acrylate” refers collectively to acrylate and methacrylate.

As used herein, “C₁-Cₙ alkyl” group refers to a monovalent group that contains 1 to n carbons atoms, that is a radical of an alkane and includes straight-chain and branched organic groups. As such, a “C₁-C₃₀ alkyl” group refers to a monovalent group that contains from 1 to 30 carbons atoms, that is a radical of an alkane and includes straight-chain and branched organic groups. Examples of alkyl groups include, but are not limited to: methyl; ethyl; propyl; isopropyl; n-butyl; isobutyl; sec-butyl; tert-butyl; n-pentyl; n-hexyl; n-heptyl; and, 2-ethylhexyl. In the present invention, such alkyl groups may be unsubstituted or may be substituted with one or more substituents selected from halogen, hydroxy, nitrile (—CN), amido and amino (—NH₂). Where applicable, a preference for a given substituent will be noted in the specification. In general, however, a preference for alkyl groups containing from 1-18 carbon atoms (C₁-C₁₈ alkyl)—for example alkyl groups containing from 1 to 12 carbon atoms (C₁-C₁₂ alkyl) or from 1 to 6 carbon atoms (C₁-C₆ alkyl)—should be noted.

The term “C₁-C₁₈ hydroxyalkyl” as used herein refers to a HO-(alkyl) group having from 1 to 18 carbon atoms, where the point of attachment of the substituent is through the oxygen-atom and the alkyl group is as defined above.

An “alkoxy group” refers to a monovalent group represented by —OA where A is an alkyl group: non-limiting examples thereof are a methoxy group, an ethoxy group and an iso-propyloxy group.

The term “C₁-C₆ alkylene” as used herein, is defined as a saturated, divalent hydrocarbon radical having straight, branched or cyclic moieties or combinations thereof and having from 1 to 6 carbon atoms.

The term “C₃-C₃₀ cycloalkyl” is understood to mean an optionally substituted, saturated, mono-, bi- or tricyclic hydrocarbon group having from 3 to 30 carbon atoms. In general, a preference for cycloalkyl groups containing from 3-18 carbon atoms (C₃-C₁₈ cycloalkyl groups) should be noted. Examples of cycloalkyl groups include: cyclopropyl; cyclobutyl; cyclopentyl; cyclohexyl; cycloheptyl; cyclooctyl; adamantane; and, norbornane. In the present invention, such cycloalkyl groups may be unsubstituted or may be substituted with one or more substituents selected from halogen, C₁-C₆ alkyl and C₁-C₆ alkoxy.

As used herein, a “C₆-C₉₈ aryl” group used alone or as part of a larger moiety—as in “aralkyl group”—refers to optionally substituted, monocyclic, bicyclic and tricyclic ring systems in which the monocyclic ring system is aromatic or at least one of the rings in a bicyclic or tricyclic ring system is aromatic. The bicyclic and tricyclic ring systems include benzofused 2-3 membered carbocyclic rings. In the present invention, such aryl groups may be unsubstituted or may be substituted with one or more substituents selected from halogen, C₁-C₆ alkyl and C₁-C₆ alkoxy. Exemplary aryl groups include: phenyl; (C₁-C₄)alkylphenyl, such as tolyl and ethylphenyl; indenyl; naphthalenyl, tetrahydronaphthyl, tetrahydroindenyl; tetrahydroanthracenyl; and, anthracenyl. And a preference for phenyl groups may be noted.

As used herein, “C₂-C₂₀ alkenyl” refers to hydrocarbyl groups having from 2 to 20 carbon atoms and at least one unit of ethylenic unsaturation. The alkenyl group can be straight chained, branched or cyclic and may optionally be substituted. The term “alkenyl” also encompasses radicals having “cis” and “trans” configurations, or alternatively, “E” and “Z” configurations, as appreciated by those of ordinary skill in the art. In general, however, a preference for unsubstituted alkenyl groups containing from 2 to 10 (C₂₋₁₀) or 2 to 8 (C₂₋₈) carbon atoms should be noted. Examples of said C₂-C₁₂ alkenyl groups include, but are not limited to: —CH═CH₂; —CH═CHCH₃; —CH₂CH═CH₂; —C(═CH₂)(CH₃); —CH═CHCH₂CH₃; —CH₂CH═CHCH₃; —CH₂CH₂CH═CH₂; —CH═C(CH₃)₂; —CH₂C(═CH₂)(CH₃); —C(═CH₂)CH₂CH₃; —C(CH₃)═CHCH₃; —C(CH₃)CH═CH₂; —CH═CHCH₂CH₂CH₃; —CH₂CH═CHCH₂CH₃; —CH₂CH₂CH═CHCH₃; —CH₂CH₂CH₂CH═CH₂; —C(═CH₂)CH₂CH₂CH₃; —C(CH₃)═CHCH₂CH₃; —CH(CH₃)CH═CHCH; —CH(CH₃)CH₂CH═CH₂; —CH₂CH═C(CH₃)₂; 1-cyclopent-1-enyl; 1-cyclopent-2-enyl; 1-cyclopent-3-enyl; 1-cyclohex-1-enyl; 1-cyclohex-2-enyl; and, 1-cyclohexyl-3-enyl.

As used herein, “alkylaryl” refers to alkyl-substituted aryl groups and “substituted alkylaryl” refers to alkylaryl groups further bearing one or more substituents as set forth above. Further, as used herein “aralkyl” means an alkyl group substituted with an aryl radical as defined above.

The term “hetero” as used herein refers to groups or moieties containing one or more heteroatoms selected from N, O, Si, P and S. Thus, for example “heterocyclic” refers to cyclic groups having N, O, Si, P or S as part of the ring structure. “Heteroalkyl”, “heterocycloalkyl” and “heteroaryl” moieties are alkyl, cycloalkyl and aryl groups as defined hereinabove, respectively, containing N, O, Si, P or S as part of their structure.

For completeness, the term “C₂-C₃₀ heteroalkyl” refers to an “alkyl” group in which at least one carbon atom has been replaced with a heteroatom, said group having from 2 to 30 carbon atoms in total. A particular example of such a heteroalkyl group is “C₂-C₁₈ alkoxyalkyl” which herein refers to an alkyl group having an alkoxy substituent as defined above and wherein the moiety (alkyl-O-alkyl) comprises in total from 1 to 18 carbon atoms: such groups include methoxymethyl (—CH₂OCH₃), 2-methoxyethyl (—CH₂CH₂OCH₃) and 2-ethoxyethyl (—CH₂CH₂OCH₂CH₃). A further example of a heteroalkyl group is “C₂-C₃₀ aminoalkyl” which herein refers to an alkyl group substituted with a least one group selected from—NH(R′), —N(R′)(R″) or N⁺(R′)(R″)(R′″) wherein R′, R″ and R′″ are C₁-C₆ alkyl subject to the proviso that the group contains in toto from 2 to 30 carbon atoms: such groups include 2-(dimethylamino)ethyl, 2-(diethylamino)ethyl and 2-(trimethylamino)ethyl.

The term “C₁-C₉ heteroaryl” denotes an aromatic group having 1-9 carbon atoms and 1-4 heteroatoms, which group may be attached via a heteroatom if feasible, or a carbon atom. The heteroaryl ring can be fused or otherwise attached to one or more heteroaryl rings, aromatic or non-aromatic hydrocarbon rings or heterocycloalkyl rings. Examples of heteroaryl groups include, but are not limited to: pyridine; furan; thiophene; 5,6,7,8-tetrahydroisoquinoline; pyrimidine; thienyl; benzothienyl; pyridyl; quinolyl; pyrazinyl; pyrimidyl; imidazolyl; benzimidazolyl; furanyl; benzofuranyl; thiazolyl; benzothiazolyl; isoxazolyl; oxadiazolyl; isothiazolyl; benzisothiazolyl; triazolyl; tetrazolyl; pyrrolyl; indolyl; pyrazolyl; and, benzopyrazolyl.

The term “C₂-C₈ heterocycloalkyl” denotes a saturated cyclic hydrocarbon group having 2-8 carbon atoms and 1-4 heteroatoms, which group may be attached via a heteroatom if feasible, or a carbon atom. The heterocycloalkyl ring can be optionally fused to or otherwise attached to other heterocycloalkyl rings and/or non-aromatic hydrocarbon rings. Preferred heterocycloalkyl groups have from 3 to 7 members. Examples of heterocycloalkyl groups include but are not limited to: piperazine; morpholine; piperidine; tetrahydrofuran; pyrrolidine; pyrazole; piperidinyl; piperazinyl; morpholinyl; and, pyrrolidinyl.

The term “aliphatic” as used herein, includes both saturated and unsaturated, non-aromatic, straight chain, branched, acyclic or cyclic hydrocarbons, which are optionally substituted with one or more functional groups, provided that substitution results in the formation of a stable moiety. As will be appreciated by the skilled artisan, “aliphatic” is intended to encompass alkyl, alkenyl, alkynyl, cycloalkyl, cycloalkenyl, and cycloalkynyl moieties.

As used herein “aromatic” refers to a major group of unsaturated cyclic hydrocarbons containing one or more rings, which group may contain carbon (C), nitrogen (N), oxygen (O), sulfur (S), boron (B) or any combination thereof. At least some carbon is included. Aromatic includes both aryl and heteroaryl rings. The aryl or heteroaryl ring may be further substituted by additional aliphatic, aromatic or other radicals, provided that substitution results in the formation of a stable moiety.

As used herein, the term “free radical initiator” refers to any chemical species which, upon exposure to sufficient energy—in the form of irradiation, heat or the like—decomposes into two parts which are uncharged, but which each possess at least one unpaired electron. For completeness, the term “free radical initiator” encompasses thermal free radical initiators and free radical photo-initiators which can be activated by an energy-carrying activation beam—such as electromagnetic radiation—upon irradiation therewith: the use of thermal free radical initiators is preferred herein.

The molecular weights referred to in this specification—to describe to macromolecular, oligomeric and polymeric components of the curable compositions—can be measured with gel permeation chromatography (GPC) using polystyrene calibration standards, such as is done according to ASTM 3536.

Viscosities of the coating compositions described herein are, unless otherwise stipulated, measured using the Brookfield Viscometer at standard conditions of 20° C. and 50% Relative Humidity (RH). The method of calibration, the spindle type and rotation speed of the Brookfield Viscometer are chosen according to the instructions of the manufacturer as appropriate for the composition to be measured.

### DETAILED DESCRIPTION OF THE INVENTION

### a) Non-Ionic Matrix Monomers

The composition of the present invention comprises at least one ethylenically unsaturated non-ionic monomer, the (co-) polymerization of which yields the matrix of the debondable adhesive. The monomer a) can, in principle, be any ethylenically unsaturated non-ionic monomer. However, the invention is particularly applicable to compositions of which (meth)acrylic monomers constitute at least 50 mole %, preferably at least 75 mole %, of the total molar amount of ethylenically unsaturated non-ionic monomers present.

### a1) Aliphatic and Cycloaliphatic (Meth)acrylate Monomers

In an important embodiment of the invention, the composition of the present invention comprises from 40 to 95 wt. %, preferably from 45 to 90 wt. %, based on the weight of the composition, of a1) at least one (meth)acrylate monomer represented by Formula I:

H₂C=CGCO₂R¹ (I)

wherein: G is hydrogen, halogen or a C₁-C₄ alkyl group; and,

R⁴ is selected from: C₁-C₃₀ alkyl; C₂-C₃₀ heteroalkyl; C₃-C₃₀ cycloalkyl; C₂-C₈ heterocycloalkyl; C₂-C₂₀ alkenyl; and, C₂-C₁₂ alkynyl.

For example, R¹ may be selected from C₁-C₁₈ alkyl, C₂-C₁₈ heteroalkyl, C₃-C₁₈ cycloalkyl; C₂-C₈ heterocycloalkyl; C₂-C₈ alkenyl, and, C₂-C₈ alkynyl.

Desirably, said monomer(s) a1) are characterized in that R¹ is selected from C₁-C₁₈ alkyl and C₃-C₁₈ cycloalkyl. This statement of preference is expressly intended to include that embodiment wherein R¹ is C₁-C₆ hydroxylalkyl.

Examples of (meth)acrylate monomers a1) in accordance with Formula (I) include but are not limited to: methyl (meth)acrylate; ethyl (meth)acrylate; butyl (meth)acrylate; hexyl (meth)acrylate; 2-ethylhexyl (meth)acrylate; dodecyl (meth)acrylate; lauryl (meth)acrylate; cyclohexyl (meth)acrylate; isobornyl (meth)acrylate; 2-hydroxyethyl (meth)acrylate (HEMA); 2-hydroxypropyl (meth)acrylate; ethylene glycol monomethyl ether (meth)acrylate; ethylene glycol monoethyl ether (meth)acrylate; ethylene glycol monododecyl ether (meth)acrylate; diethylene glycol monomethyl ether (meth)crylate; trifluoroethyl (meth)acrylate; and, perfluorooctyl (meth)acrylate.

### a2) Aromatic (Meth)Acrylate Monomers

The composition of the present invention may further comprise from 0 to 30 wt. %, for example from 0.1 to 30 wt. %, from 0.1 to 25 wt. % or from 0.1 to 15 wt. %, based on the weight of the composition, of a2) at least one (meth)acrylate monomer represented by Formula II:

H₂C=CQCO₂R² (II)

wherein: Q may be hydrogen, halogen or a C₁-C₄ alkyl group; and,

R² may be selected from C₆-C₁₈ aryl, C₁-C₉ heteroaryl, C₇-C₁₈ alkaryl and C₇-C₁₈ aralkyl.

Exemplary (meth)acrylate monomers a2) in accordance with Formula (II)—which may be used alone or in combination—include but are not limited to: benzyl (meth)acrylate; phenoxyethyl (meth)acrylate; phenoxydiethylene glycol (meth)acrylate; phenoxypropyl (meth)acrylate; and, phenoxydipropylene glycol (meth)acrylate.

### a3) (Meth)Acrylate-Functionalized Oligomer

In an important embodiment of the invention—which is not intended to be mutually exclusive of the inclusion of aliphatic and cycloaliphatic monomers (a1) and aromatic monomers (a2)—the compositions of the present invention should comprise from 0 to 50 wt. %, preferably from 5 to 25 wt. %, based on the weight of the composition, of a3) at least one (meth)acrylate-functionalized oligomer. Said oligomers may have one or more acrylate and/or methacrylate groups attached to the oligomeric backbone, which (meth)acrylate functional groups may be in a terminal position on the oligomer and/or may be distributed along the oligomeric backbone.

It is preferred that said at least one (meth)acrylate functionalized oligomers: i) have two or more (meth)acrylate functional groups per molecule; and/or, ii) have a weight average molecular weight (Mw) of from 300 to 1000 daltons.

Examples of such oligomers, which may be used alone or in combination, include but are not limited to: (meth)acrylate-functionalized urethane oligomers such as (meth)acrylate-functionalized polyester urethanes and (meth)acrylate-functionalized polyether urethanes; (meth)acrylate-functionalized polyepoxide resins; (meth)acrylate-functionalized polybutadienes; (meth)acrylic polyol (meth)acrylates; polyester (meth)acrylate oligomers; polyamide (meth)acrylate oligomers; and, polyether (meth)acrylate oligomers. Such (meth)acrylate-functionalized oligomers and their methods of preparation are disclosed in interalia: U.S. Pat. Nos. 4,574,138; 4,439,600; 4,380,613; 4,309,526; 4,295,909; 4,018,851; 3,676,398; 3,770,602; 4,072,529; 4,511,732; 3,700,643; 4,133,723; 4,188,455; 4,206,025; 5,002,976. Of the aforementioned polyether (meth)acrylates oligomers, specific examples include but are not limited to: PEG 200 DMA (n=4); PEG 400 DMA (n=9); PEG 600 DMA (n=14); and, PEG 800 DMA (n=19), in which the assigned number (e.g., 400) represents the weight average molecular weight of the glycol portion of the molecule.

The present invention does not preclude the presence of further ethylenically unsaturated non-ionic monomers not conforming to the definitions of a1), a2) and a3). However, the addition of such further monomers should be constrained by the condition that the total amount of ethylenically unsaturated non-ionic monomers should not exceed 95 wt. %, based on the total weight of the composition. Desirably, the total of ethylenically unsaturated non-ionic monomers should not exceed 90 wt. %, based on the total weight of the composition.

Without intention to limit the present invention, such further ethylenically unsaturated non-ionic monomers may include: silicone (meth)acrylate monomers, such as those taught by and claimed in U.S. Pat. No. 5,605,999 (Chu); α,β-ethylenically unsaturated monocarboxylic acids containing 3 to 5 carbon atoms such as acrylic acid, methacrylic acid, crotonic acid; C₁-C₁₈ alkyl esters of crotonic acid; α,β-ethylenically unsaturated dicarboxylic acids containing from 4 to 6 carbon atoms and the anhydrides, monoesters, and diesters of those acids; vinyl esters such as vinyl acetate, vinyl propionate and monomers of the VEOVA™ series available from Shell Chemical Company; vinyl and vinylidene halides; vinyl ethers such as vinyl ethyl ether; vinyl ketones including alkyl vinyl ketones, cycloalkyl vinyl ketones, aryl vinyl ketones, arylalkyl vinyl ketones, and arylcycloalkyl vinyl ketones; aromatic or heterocyclic aliphatic vinyl compounds; poly(meth)acrylates of alkane polyols, such as ethylene glycol di(meth)acrylate, propylene glycol di(meth)acrylate, butylene glycol di(meth)acrylate, neopentyl glycol di(meth)acrylate, hexylene glycol di(meth)acrylate, trimethylolpropane tri(meth)acrylate, glycerin tri(meth)acrylate, and pentaerythritol tetra(meth)acrylate; poly(meth)acrylates of oxyalkane polyols such as diethylene glycol di(meth)acrylate, dipropylene glycol di(meth)acrylate, triethylene glycol di(meth)acrylate, tetraethylene glycol di(meth)acrylate, dibutylene glycol di(meth)acrylate, di(pentamethylene glycol)dimethacrylate; polyethylene glycol di(meth)acrylates; and, bisphenol-A di(meth)acrylates, such as ethoxylated bisphenol-A (meth)acrylate (“EBIPMA”).

Representative examples of other ethylenically unsaturated polymerizable non-ionic monomers include, without limitation: ethylene glycol dimethacrylate (EGDMA); fumaric, maleic, and itaconic anhydrides, monoesters and diesters with C₁-C₄ alcohols such as methanol, ethanol, propanol, isopropanol, butanol, isobutanol, and tert-butanol. Representative examples of vinyl monomers include, without limitation, such compounds as: vinyl acetate; vinyl propionate; vinyl ethers, such as vinyl ethyl ether; and, vinyl ethyl ketone. Representative examples of aromatic or heterocyclic aliphatic vinyl compounds include, without limitation, such compounds as styrene, α-methyl styrene, vinyl toluene, tert-butyl styrene, 2-vinyl pyrrolidone, 5-ethylidene-2-norbornene and 1-, 3-, and 4-vinylcyclohexene.

### b) Electrolyte

The composition of the present invention comprises from 0.9 to 50 wt. %, for example from 5 to 50 wt. % or from 10 to 45 wt. %, of b) at least one polymerizable ionic compound, wherein said polymerizable ionic compound comprises:

b1) at least one compound in accordance with general formula IV:

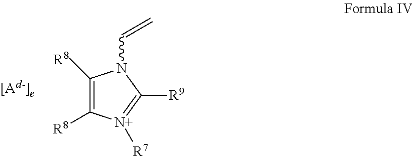

and/or

b2) at least one compound in accordance with general formula V:

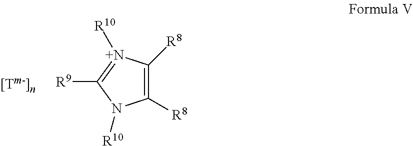

wherein: R⁷ is selected from: C₁-C₃₀ alkyl; C₂-C₈ alkenyl; C₁-C₃₀ heteroalkyl; C₃-C₃₀ cycloalkyl; C₆-C₁₈ aryl; C₁-C₉ heteroaryl; C₇-C₁₈ alkylaryl; C₂-C₅ heterocycloalkyl; or, —R^{a}—C(═O)—R^{b} where R^{a} is a C₁-C₆ alkylene group and R^{b} is a C₁-C₆ alkyl group;

each R⁸ is independently selected from H, C₁-C₁₈ alkyl, C₁-C₁₈ heteroalkyl; C₃-C₁₈ cycloalkyl, C₆-C₁₈ aryl, C₁-C₉ heteroaryl, C₇-C₁₈ alkylaryl; or, C₂-C₅ heterocycloalkyl;

R⁹ is H or C₁-C₄ alkyl;

each R¹⁰ is independently selected from: C₁-C₃₀ alkyl; C₁-C₃₀ heteroalkyl; C₃-C₃₀ cycloalkyl; C₆-C₁₈ aryl; C₁-C₉ heteroaryl; C₇-C₁₈ alkylaryl; C₂-C₅ heterocycloalkyl; or, —R^{a}—C(═O)—R^{b} where R^{a} is a C₁-C₆ alkylene group and R^{b} is a C₁-C₆ alkyl group;

A is a non-polymerizable anion;

T is an ethylenically unsaturated anion;

d and m are each integers having a value of at least 1;

e and n have a numeric value such that the compound is electrically neutral; and,

[symbol] is a covalent bond, C₁-C₂ alkylene, —CH₂OC(═O)—, —CH₂CH₂OC(═O)—, p-benzyl or p-tolyl.

In the above formulae, R⁷ is preferably selected from C₁-C₁₂ alkyl; C₂-C₆ alkenyl; C₁-C₁₂ heteroalkyl; C₃-C₁₈ cycloalkyl; C₆-C₁₈ aryl; C₁-C₉ heteroaryl; C₇-C₁₈ alkylaryl; C₂-C₅ heterocycloalkyl; or, —R^{a}—C(═O)—R^{b} where R^{a} is a C₁-C₆ alkylene group and R^{b} is a C₁-C₆ alkyl group. R⁷ is more particularly selected from C₁-C₈ alkyl; C₂-C₄ alkenyl; C₁-C₈ heteroalkyl; C₃-C₁₂ cycloalkyl; C₆-C₁₈ aryl; C₁-C₉ heteroaryl; C₇-C₁₈ alkylaryl; C₂-C₅ heterocycloalkyl; or, —R^{a}—C(═O)—R^{b} where R^{a} is a C₁-C₄ alkylene group and R^{b} is a C₁-C₄ alkyl group. Given that R⁷ may be an alkenyl group, it is noted that the imidazolium moiety may possess more than one ethylenically unsaturated group: exemplary moieties in this regard include: 1-H-imidazolium, 1-3-diethenyl; and, 1-H-imidazolium, 3-ethenyl-1-(2-propen-1-yl)-.

Each R⁸ is preferably independently selected from H or C₁-C₆ alkyl and, more particularly, is independently selected from H or C₁-C₂ alkyl. A preference that at least one R⁸ is H may be mentioned. R⁹ is preferably H or C₁-C₂ alkyl and, more particularly, is H or methyl.

Each R¹⁰ is preferably independently selected from C₁-C₁₂ alkyl; C₁-C₁₂ heteroalkyl; C₃-C₁₈ cycloalkyl; C₆-C₁₈ aryl; C₁-C₉ heteroaryl; C₇-C₁₈ alkylaryl; C₂-C₅ heterocycloalkyl; or, —R^{a}—C(═O)—R^{b} where R^{a} is a C₁-C₆ alkylene group and R^{b} is a C₁-C₆ alkyl group. R¹⁰ is more particularly selected from: C₁-C₈ alkyl; C₁-C₈ heteroalkyl; C₃-C₁₂ cycloalkyl; C₆-C₁₈ aryl; C₁-C₉ heteroaryl; C₇-C₁₈ alkylaryl; C₂-C₅ heterocycloalkyl; or, —R^{a}—C(═O)—R^{b} where R^{a} is a C₁-C₄ alkylene group and R^{b} is a C₁-C₄ alkyl group.

Having regard to compounds of Formula IV, the anion A is typically selected from the group consisting of: fluoride; chloride; bromide; iodide; perchlorate; nitrate; nitrite; phosphate; sulfate; sulfite; carbonate; hydrogencarbonate; hydrogenphosphate; hydrogensulfate; hydrogensulfite; dihydrogenphosphate; trifluorophosphate, hexafluorophosphate; methylsulfate; ethylsulfate; methylcarbonate; methylsulfonate; ethylsulfonate; 4-methylbenzenesulfonate; diethylphosphate; formate; acetate; propionate; tartrate; octanoate; bis(2,4,4-trimethylpentyl)phosphinate; bis(malonato)borate; bis(oxalato)borate; bis(pentafluoroethyl)phosphinate; tetracyanoborate; tetrafluoroborate; bis(phthalato)borate; bis(salicylato)borate; bis(trifluoromethylsulfonate)imide; bis(trifluoromethanesulfonyl)methane; bis(trifluoromethyl)imidate; tetrakis(hydrogensulfato)borate; tetrakis(methylsulfonato)borate; trifluoromethylsulfonate; tris(heptafluoropropyl)trifluorophosphate; tris(nonafluorobutyl)trifluorophosphate; tris(pentafluoroethyl)trifluorophosphate; tris(pentafluoroethylsulfonyl)trifluorophosphate; trichlorozincate; trifluoroacetate; bromoaluminates; chloroaluminates; dichlorocuprate; thiocyanate; tosylate; and, dicyanamide.

The anion A is preferably selected from the group consisting: fluoride; chloride; bromide; iodide; perchlorate; nitrate; formate; acetate; octanoate; tetrafluoroborate; trifluorophosphate; hexafluorophosphate; methylsulfate; ethylsulfate; methylcarbonate; methylsulfonate; 4-methylbenzenesulfonate; trifluoromethylsulfonate; bis(trifluoromethylsulfonate)imide, trifluorophosphate and, trifluoroacetate; and, tris(perfluoroethyl)trifluorophosphate.

More particularly, the anion A is selected from the group consisting of: fluoride; chloride; bromide; iodide; tetrafluoroborate; hexafluorophosphate; methylsulfate; ethylsulfate; methylsulfonate; 4-methylbenzenesulfonate; and, bis(trifluoromethylsulfonate)imide.

The anion T may be selected from: ethylenically unsaturated carboxylate anions (R—COO—); ethylenically unsaturated sulphonate anions (R—SO₃⁻); ethylenically unsaturated phosphonate anions (R—PO₃²⁻); ethylenically unsaturated phosphinate anions (R—P(H)O₂⁻); and, ethylenically unsaturated phosphate anions (R—O—PO₃²⁻), wherein R is an organic radical comprising an ethylenic unsaturation which polymerizes under normal conditions and which radical is preferably derived from (meth)acrylic acid, vinylic acid or allylic acid.

Representative anions T include: (meth)acrylate; itaconate; maleate; crotonate; isocrotonate; vinylbenzoate; 2-acrylamido-2-methyl propane sulfonate; sulphoethyl (meth)acrylate; sulfopropyl (meth)acrylate; sulphomethylated acrylamide; allyl sulphonate; vinyl sulphonate; 4-vinylbenzene sulfonate (4-stryene sulfonate); 4-isopropenylbenzene sulfonate (4-methylstyrene sulfonate); allyl phosphonate; and, monoacryloxyethyl phosphate.

Illustrative compounds b1) according to Formula IV include but are not limited to: 1H-Imidazolium, 3-ethenyl-1-methyl-, iodide; 1H-Imidazolium, 3-ethenyl-1-methyl-, chloride; 1H-Imidazolium, 3-ethenyl-1-methyl-, bromide; 1H-Imidazolium, 3-ethenyl-1-methyl-, methanesulfonate; 1H-Imidazolium, 3-ethenyl-1-ethyl-, 1,1,1-trifluoro-N-[(trifluoromethyl)sulfonyl]methanesulfonamide; 1H-Imidazolium, 3-ethenyl-1-methyl-, 1,1,1-trifluoro-N-[(trifluoromethyl)sulfonyl]methanesulfonamide; 1H-Imidazolium, 3-ethenyl-1-methyl-, hexafluorophosphate; 1H-Imidazolium, 3-ethenyl-1-methyl-, 4-methylbenzenesulfonate; 1H-Imidazolium, 3-ethenyl-1-methyl-, tetrafluoroborate; 1H-Imidazolium, 3-ethenyl-1-ethyl-, iodide; 1H-Imidazolium, 3-ethenyl-1-ethyl-, bromide; 1H-Imidazolium, 3-ethenyl-1-ethyl-, 1,1,1-trifluoro-N-[(trifluoromethyl)sulfonyl]methanesulfonamide; 1H-Imidazolium, 3-ethenyl-1-ethyl-, hexafluorophosphate; 1H-Imidazolium, 3-ethenyl-1-ethyl-, tetrafluoroborate; 1H-Imidazolium, 1,3-diethenyl-, chloride; 1H-Imidazolium, 1,3-diethenyl-, tetrafluoroborate; 1H-Imidazolium, 1,3-diethenyl-, hexafluorophosphate; 1H-Imidazolium, 3-ethenyl-1-ethyl-2-methyl-, iodide; 1H-Imidazolium, 3-ethenyl-1,2-dimethyl-, iodide; 1H-Imidazolium, 3-ethenyl-1,2-dimethyl-, chloride; 1H-Imidazolium, 3-ethenyl-2-ethyl-1-methyl-, iodide; 1H-Imidazolium, 3-(aminomethyl)-1-ethenyl-, bromide; 1H-Imidazolium, 3-ethenyl-1-(1-methylethyl)-, bromide; 1H-Imidazolium, 3-(1,1-dimethylethyl)-1-ethenyl-, bromide; 1H-Imidazolium, 3-ethenyl-1-propyl-, bromide; 1H-Imidazolium, 1-(2-aminoethyl)-3-ethenyl-, chloride; 1H-Imidazolium, 1-(cyanomethyl)-3-ethenyl-, bromide; 1H-Imidazolium, 1-[2-(diethylamino)ethyl]-3-ethenyl-, chloride; 1H-Imidazolium, 3-ethenyl-1-(2-propen-1-yl)-, chloride; 1H-Imidazolium, 3-ethenyl-1-(2-propen-1-yl)-, 1,1,1-trifluoro-N-[(trifluoromethyl) sulfonyl]methanesulfonamide; 1H-Imidazolium, 3-ethenyl-1-(2-propen-1-yl)-, bromide; 1H-Imidazolium, 3-ethenyl-1-(phenylmethyl)-, bromide; 1H-Imidazolium, 1-ethenyl-3-(4-methylphenyl)-, chloride; 1H-Imidazolium, 3-ethenyl-1-(2-hydroxyethyl)-, chloride; 1H-Imidazolium, 3-ethenyl-1-(1-methylpropyl)-, chloride; 1H-Imidazolium, 1-butyl-3-ethenyl-, bromide; 1H-Imidazolium, 3-ethenyl-1-(2-ethoxyethyl)-, bromide; 1H-Imidazolium, 1-methyl-3-(2-propen-1-yl)-, iodide; 1H-Imidazolium, 1-methyl-3-(2-propen-1-yl)-, chloride; 1H-Imidazolium, 1-methyl-3-(2-propen-1-yl)-, 1,1,1-trifluoro-N-[(trifluoromethyl)sulfonyl]methanesulfonamide; 1H-Imidazolium, 1-methyl-3-(2-propen-1-yl)-, hexafluorophosphate; 1H-Imidazolium, 1-methyl-3-(2-propen-1-yl)-, tetrafluoroborate; 1H-Imidazolium, 1-ethyl-3-(2-propen-1-yl)-, iodide; 1H-Imidazolium, 2-methyl-3-(2-propen-1-yl)-1-propyl-, bromide; 1H-Imidazolium, 3-(2-propen-1-yl)-1-propyl-, bromide; 1H-Imidazolium, 3-(2-hydroxyethyl)-1-(2-propen-1-yl)-, bromide; 1H-Imidazolium, 1-butyl-3-(2-propen-1-yl)-, bromide; 1H-Imidazolium, 1,3-di-2-propen-1-yl-, bromide; 1H-Imidazolium, 1,3-di-2-propen-1-yl-, 1,1,1-trifluoro-N-[(trifluoromethyl)sulfonyl]methanesulfonamide; 1H-Imidazolium, 1,3-di-2-propen-1-yl-, tetrafluoroborate; 1H-Imidazolium, 3-(2-hydroxyethyl)-1-(2-propen-1-yl)-, bromide; 1H-Imidazolium, 1-(2-cyanoethyl)-3-(2-propen-1-yl)-, bromide; 1H-Imidazolium, 1-methyl-3-(2-oxopropyl)-, tetrafluoroborate; 1H-Imidazolium, 3-[(4-ethenylphenyl)methyl]-1-methyl-, iodide; 1H-Imidazolium, 3-[(4-ethenylphenyl)methyl]-1-methyl-, chloride; 1H-Imidazolium, 3-[(4-ethenylphenyl)methyl]-1-methyl-, 1,1,1-trifluoro-N-[(trifluoromethyl)sulfonyl]methanesulfonamide; 1H-Imidazolium, 3-[(4-ethenylphenyl)methyl]-1-methyl-, hexafluorophosphate; 1H-Imidazolium, 3-[(4-ethenylphenyl)methyl]-1-methyl-, tetrafluoroborate; 1H-Imidazolium, 3-[(4-ethenylphenyl)methyl]-1-ethyl-, chloride; 1H-Imidazolium, 1-[(4-ethenylphenyl)methyl]-3-ethyl-, salt with 1,1,1-trifluoro-N-[(trifluoromethyl)sulfonyl]methanesulfonamide; 1H-Imidazolium, 1-(3-aminopropyl)-3-[(4-ethenylphenyl)methyl]-, chloride; 1H-Imidazolium, 1-butyl-3-[(4-ethenylphenyl)methyl]-, chloride; 1H-Imidazolium, 1-methyl-3-[[(1-oxo-2-propen-1-yl)oxy]methyl]-, bromide; 1H-Imidazolium, 1-ethyl-3-[[(1-oxo-2-propen-1-yl)oxy]methyl]-, iodide; and, 1H-Imidazolium, 1-butyl-3-[[(1-oxo-2-propen-1-yl)oxy]methyl]-, iodide. For completeness, such compounds can be present alone or in combination of two or more in the present composition.

Without intention to limit the present invention, representative compounds in accordance with Formula IV include:

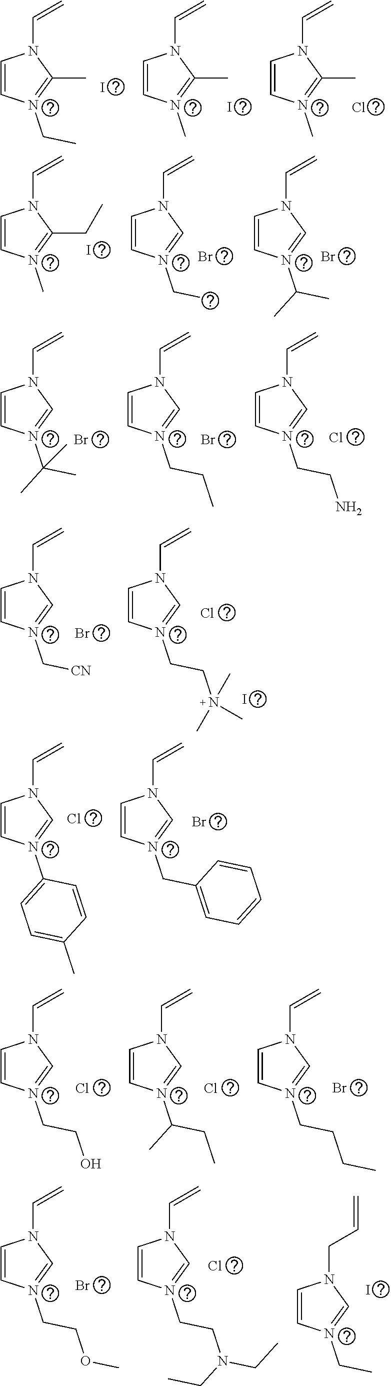

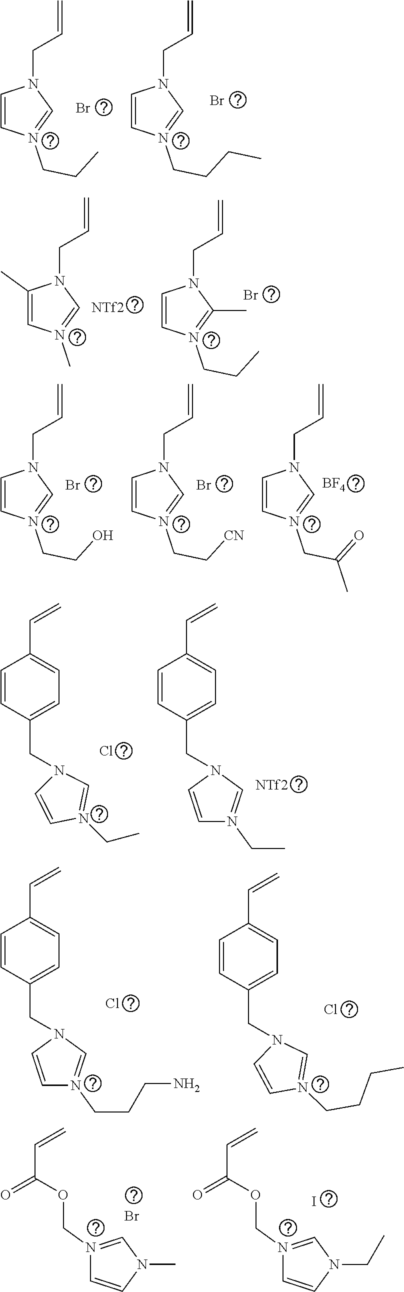

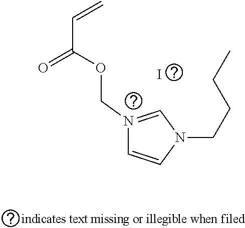

For completeness, in the above illustrations NTf2—denotes the bistrifluoromethanesulfonimidate anion.

Illustrative compounds b2) according to Formula V include but are not limited to: 1H-Imidazolium, 3-(3-cyanopropyl)-1-methyl-, 2-propenoate; 1H-Imidazolium, 3-hexyl-1-methyl-, 2-propenoate; 1H-Imidazolium, 3-hexadecyl-1-methyl-, 2-propenoate; 1H-Imidazolium, 3-ethyl-1-methyl-, 2-methyl-2-propenoate; 1H-Imidazolium, 1-methyl-3-(phenylmethyl)-, 2-methyl-2-propenoate; 1H-Imidazolium, 3-ethyl-1-methyl-, 1-[2-[(1-oxo-2-propen-1-yl)oxy]ethyl] 1,2-benzenedicarboxylate; 1H-Imidazolium, 3-ethyl-1-methyl-, 2-methyl-2-[(1-oxo-2-propen-1-yl)amino]-1-propanesulfonate; 1H-Imidazolium, 3-butyl-1-methyl-, 3-sulfopropyl 2-methyl-2-propenoate; 1H-Imidazolium, 3-ethyl-1-methyl-, salt with 2-(phosphonooxy)ethyl 2-methyl-2-propenoate; 1H-Imidazolium, 1-methyl-3-hexyl-, 4-ethenylbenzenesulfonate; 1H-Imidazolium, 1-dodecyl-3-ethenyl-, 4-ethenylbenzenesulfonate; 1H-Imidazolium, 3-ethenyl-1-hexadecyl-, 4-ethenylbenzenesulfonate; 1H-Imidazolium, 1-methyl-3-propyl-, 4-ethenylbenzenesulfonate; and, 1H-Imidazolium, 3-ethyl-1-methyl-, 4-(1-methylethenyl)benzenesulfonate. For completeness, such compounds can be present alone or in combination of two or more in the present composition.

Without intention to limit the present invention, representative compounds in accordance with Formula V include:

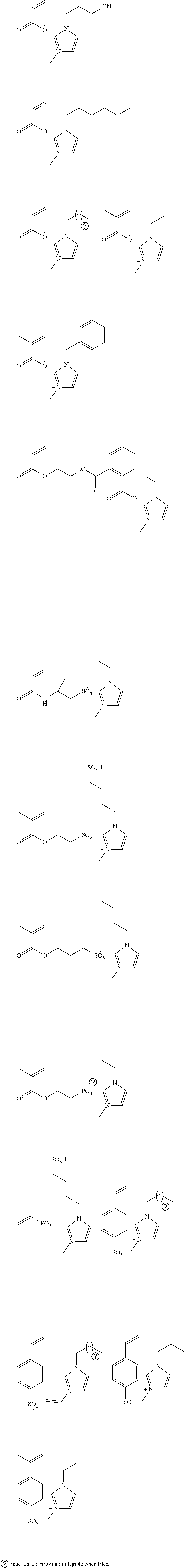

It is noted that the electrically debondable adhesive formulation can in certain embodiments contain both of: b1) one or more compounds according to Formula IV; and, b2) one or more compounds according to Formula V. When both are present, it is preferred that the ratio of b1) to b2) is from 5:1 to 1:1, for example from 4:1 to 2:1.

### c) Free Radical Initiator

The composition of the present invention includes c) at least one free radical initiator. The composition should conventionally comprise from 0.1 to 10 wt. %, for example from 0.1 to 5 wt. % or from 0.1 to 2.5 wt. %, of c) said at least one free radical initiator, based on the total weight of the composition.

Without intention to limit the present invention, an exemplary class of free radical initiators suitable for use herein are organic peroxides, selected for example from: cyclic peroxides; diacyl peroxides; dialkyl peroxides; hydroperoxides; peroxycarbonates; peroxydicarbonates; peroxyesters; and, peroxyketals.

While certain peroxides—such as dialkyl peroxides—have been disclosed as useful initiators in inter alia U.S. Pat. No. 3,419,512 (Lees) and U.S. Pat. No. 3,479,246 (Stapleton) and indeed may have utility herein, hydroperoxides represent a preferred class of initiator for the present invention. Further, whilst hydrogen peroxide itself may be used, the most desirable polymerization initiators are the organic hydroperoxides. For completeness, included within the definition of hydroperoxides are materials such as organnic neroxides or organic peresters which decompose or hydrolyze to form organic hydroperoxides in situ: examples of such peroxides and peresters are cyclohexyl and hydroxycyclohexyl peroxide and t-butyl perbenzoate, respectively.

In an embodiment of the invention, the free radical initiator comprises or consists of at least one hydroperoxide compound represented by the formula:

R^{p}OOH

wherein: R^{p} is an aliphatic or aromatic group containing up to 18 carbon atoms, and preferably wherein: R^{p} is a C₁-C₁₂ alkyl, C₆-C₁₈ aryl or C₇-C₁₈ aralkyl group.

As exemplary peroxide initiators, which may be used alone or in combination, there may be mentioned: cumene hydroperoxide (CHP); para-menthane hydroperoxide; t-butyl hydroperoxide (TBH); t-butyl perbenzoate; t-butyl peroxy pivalate; di-t-butyl peroxide; t-butyl peroxy acetate; t-butyl peroxy-2-hexanoate; t-amyl hydroperoxide; 1,2,3,4-tetramethylbutyl hydroperoxide; benzoyl peroxide; dibenzoyl peroxide; 1,3-bis(t-butylperoxyisopropyl) benzene; diacetyl peroxide; butyl 4,4-bis (t-butylperoxy) valerate; p-chlorobenzoyl peroxide; t-butyl cumyl peroxide; di-t-butyl peroxide; dicumyl peroxide; 2,5-dimethyl-2,5-di-t-butylperoxyhexane; 2,5-dimethyl-2,5-di-t-butyl-peroxyhex-3-yne; and, 4-methyl-2,2-di-t-butylperoxypentane.

Without intention to limit the present invention, a further exemplary class of free radical initiators suitable for use herein are azo polymerization initiators, selected for example from: azo nitriles; azo esters; azo amides; azo amidines; azo imidazoline; and, macro azo initiators.

As representative examples of suitable azo polymerization initiators may be mentioned: 2,2′-azobis (2-methylbutyronitrile); 2,2′-azobis(isobutyronitrile); 2,2′-azobis(2,4-dimethylvaleronitrile); 2,2′-azobis(4-methoxy-2,4-dimethylvaleronitrile); 1,1′-azobis(cyclohexane-1-carbonitrile); 4,4′-azobis(4-cyanovaleric acid); dimethyl 2,2′-azobis(2-methylpropionate); 2,2′-azobis[2-methyl-N-(2-hydroxyethyl)propionamide]; 2,2′-azobis (N-butyl-2-methylpropionamide); 2,2′-azobis[2-(2-imidazolin-2-yl)propane]dihydrochloride; 2,2′-azobis[2-(2-imidazolin-2-yl)propane]; 2,2′-azobis(2-methylpropionamidine)dihydrochloride; 2,2′-azobis[N-(2-carboxyethyl)-2-methylpropionamidine]tetrahydrate; 4,4-azobis(4-cyanovaleric acid), polymer with alpha, omega-bis(3-aminopropyl)polydimethylsiloxane (VPS-1001, available from Wako Pure Chemical Industries, Ltd.); and, 4,4′-azobis(4-cyanopentanoic acid)-polyethyleneglycol polymer (VPE-0201, available from Wako Pure Chemical Industries, Ltd.).

It is not precluded that the compositions of the present invention may include at least one free radical photoinitiator compound which initiates the polymerization or hardening of the compositions upon irradiation with actinic radiation.

Typically, free radical photoinitiators are divided into those that form radicals by cleavage, known as “Norrish Type I”, and those that form radicals by hydrogen abstraction, known as “Norrish Type II”. The Norrish Type II photoinitiators require a hydrogen donor, which serves as the free radical source: as the initiation is based on a bimolecular reaction, the Norrrish Type II photoinitiators are generally slower than Norrish Type I photoinitiators which are based on the unimolecular formation of radicals. On the other hand, Norrish Type II photoinitiators possess better optical absorption properties in the near-UV spectroscopic region. The skilled artisan should be able to select an appropriate free radical photoinitiator based on the actinic radiation being employed in curing and the sensitivity of the photoinitiator(s) at that wavelength.

Preferred free radical photoinitiators are those selected from the group consisting of: benzoylphosphine oxides; aryl ketones; benzophenones; hydroxylated ketones; 1-hydroxyphenyl ketones; ketals; and, metallocenes. For completeness, the combination of two or more of these photoinitiators is not precluded in the present invention.

Particularly preferred free radical photoinitiators are those selected from the group consisting of: benzoin dimethyl ether; 1-hydroxycyclohexyl phenyl ketone; benzophenone; 4-chlorobenzophenone; 4-methylbenzophenone; 4-phenylbenzophenone; 4,4′-bis(diethylamino) benzophenone; 4,4′-bis(N,N′-dimethylamino) benzophenone (Michler's ketone); isopropylthioxanthone; 2-hydroxy-2-methylpropiophenone (Daracur 1173); 2-methyl-4-(methylthio)-2-morpholinopropiophenone; methyl phenylglyoxylate; methyl 2-benzoylbenzoate; 2-ethylhexyl 4-(dimethylamino)benzoate; ethyl 4-(N,N-dimethylamino)benzoate: phenylbis(2,4,6-trimethylbenzoyl)phosphine oxide; diphenyl(2,4,6-trimethylbenzoyl)phosphine oxide; and, ethyl phenyl(2,4,6-trimethylbenzoyl)phosphinate. Again, for surety, the combination of two or more of these photoinitiators is not precluded in the present invention.

Where the composition of the present invention comprises a free radical photoinitiator, irradiation of said curable compositions generates the active species from the photoinitiator(s) which initiates the cure reactions. Once that species is generated, the cure chemistry is subject to the same rules of thermodynamics as any chemical reaction: the reaction rate may be accelerated by heat. The practice of using thermal treatments to enhance the actinic-radiation cure of monomers is generally known in the art.

As would be recognized by the skilled artisan, photosensitizers can be incorporated into the compositions to improve the efficiency with which a photoinitiator c) uses the energy delivered. The term “photosensitizer” is used in accordance with its standard meaning to represent any substance that either increases the rate of photoinitiated polymerization or shifts the wavelength at which polymerization occurs. Photosensitizers should be used in an amount of from 0 to 25 wt. %, based on the weight of said free radical photoinitiator.

The use of the free radical (photo)initiator may produce residue compounds from the (photo)chemical reaction in the final cured product. The residues may be detected by conventional analytical techniques such as: infrared, ultraviolet and NMR spectroscopy; gas or liquid chromatography; and, mass spectroscopy. Thus, the present invention may comprise cured matrix (co-)polymers and detectable amounts of residues from a free radical (photo-)initiator. The residues are present in small amounts and do not normally interfere with the desired physiochemical properties of the final cured product.

### d) Solubilizer

The compositions of the present invention may optionally comprise a solubilizer. The compositions may, for instance, contain from 0.1 to 10 wt. % or from 0.1 to 5 wt. % of solubilizer, based on the weight of the composition. The solubilizer has the function of promoting the miscibility of the electrolyte b) within the adhesive composition: the solubilizer may or may not form part of the polymer matrix formed upon curing of the adhesive composition but does serve to facilitate ion transfer therein. The solubilizer is, as such, preferably a polar compound and should desirably be liquid at room temperature.

Suitable classes of solubilizer include: polyphosphazenes; polymethylenesulfides; polyoxyalkylene glycols; polyethylene imines; silicone surfactants, such as polyalkylsiloxane and polyoxyalkylene modified polydimethylsiloxanes including but not limited to poly(C2-C3)oxyalkylene modified polydimethylsiloxanes; co-polymers of functionalized polyalkysiloxanes and epoxy resins, such as copolymers of polydimethylsiloxane (PDMS) and epoxy resin; polyhydric alcohols; and, sugars. For completeness, fluorinated silicone surfactants, such as fluorinated polysilanes, are intended to be encompassed within the term silicone surfactants.

Polyhydric alcohols and sugars such as ethylene glycol, 1,3-propanediol, cyclohexandiol, hydroquinone, catechol, resorcinol, phloroglucinol, pyrogallol, hydroxyhydroquinone, tris(hydroxymethyl)benzene, tris(hydroxymethyl)benzene with three methyl or ethyl substituents bonded to the remaining benzene carbon atoms, isosorbide, isomannide, isoidide, glycerol, cyclohexane-1,2,4-triol, 1,3,5-cyclohexanetriol, pentane-1,2,3-triol, hexane-1,3,5-triol, erythritol, 1,2,4,5-tetrahydroxybenzene, threitol, arabitol, xylitol, ribitol, mannitol, sorbitol, inositol, fructose, glucose, mannose, lactose, 1,1,1-tris(hydroxymethyl)propane, 1,1,1-tris(hydroxymethyl)ethane, di(trimethylolpropane), trimethylolpropane ethoxylate, 2-hydroxymethyl-1,3-propanediol, pentaerythritol allyl ether and pentaerythritol.

Of the polyoxyalkylene glycols, a particular preference for the use of polyoxy(C₂-C₃)alkylene glycols having a weight average molecular weight of from 200 to 10000 g/mol, for example 200 to 2000 g/mol, may be noted.

### Additives and Adjunct Ingredients

Said compositions obtained in the present invention will typically further comprise adjuvants and additives that can impart improved properties to these compositions. For instance, the adjuvants and additives may impart one or more of: improved elastic properties; improved elastic recovery; longer enabled processing time; faster curing time; and, lower residual tack. Included among such adjuvants and additives are: non-polymerizable electrolyte; tougheners; electrically conductive particles; electrically non-conductive fillers; catalysts; plasticizers; stabilizers including UV stabilizers; antioxidants; reactive diluents; drying agents; adhesion promoters; fungicides; flame retardants; rheological adjuvants; color pigments or color pastes; and/or optionally also, to a small extent, non-reactive diluents.

Such adjuvants and additives can be used in such combination and proportions as desired, provided they do not adversely affect the nature and essential properties of the composition. While exceptions may exist in some cases, these adjuvants and additives should not in toto comprise more than 20 wt. % of the total composition and preferably should not comprise more than 10 wt. % of the composition.

The presence of non-polymerizable electrolyte in the present composition is not precluded. Illustrative electrolytes include the non-polymerizable salts of cations selected from the group consisting of: ammonium; pyridinium; phosphonium; imidazolium; oxazolium; guadinium; and, thiazolium. Whilst the anion of such non-polymerizable salts is not particularly limited, preferred anions are selected from the group consisting of: halides; pseudohalides and halogen-containing compounds of the formulae PFe⁻, CF₃SO₃⁻, (CF₃SO₃)₂N⁻, CF₃CO₂⁻ and CCl₃CO₂⁻; carboxylic acid anions, in particular formate, acetate, propionate, butyrate and lactate; hydroxycarboxylic acid anions; pyridinates and pyrimidinates; carboxylic acid imides, bis(sulfonyl)imides and sulfonylimides; sulfates, in particular methyl sulfate and ethyl sulfate; sulfites; sulfonates, in particular methansulfonate; and, phosphates, in particular dimethyl-phosphate, diethyl-phosphate and di-(2-ethylhexyl)-phosphate.

When included in the composition, non-polymerizable electrolyte should be present in an amount less than 10 wt. % of the total weight of polymerizable ionic compounds (part b)).

The presence of tougheners in the present composition can be advantageous to the debonding of the cured adhesive. Without intention to be bound by theory, the tougheners facilitate phase separation within the cured adhesive under the application of an electrical potential. Good debonding results have, in particular, been obtained where the composition of the present invention comprises at least one toughener selected from: epoxy-elastomer adducts; and, toughening rubber in the form of core-shell particles dispersed in the matrix polymer.

Elastomer-containing adducts may be used individually or a combination of two or more particular adducts might be used. Moreover, each adduct may independently be selected from solid adducts or liquid adducts at a temperature of 23° C. Typically, useful adducts will be characterized by a ratio by weight of epoxy to elastomer of from 1:5 to 5:1, for example from 1:3 to 3:1. And an instructive reference regarding suitable epoxy/elastomer adducts is US Patent Publication 2004/0204551. Moreover, exemplary commercial epoxy/elastomer adducts for use herein include but are not limited to: HYPDX RK8-4 commercially available from CVC Chemical; and, B-Tough A3 available from Croda Europe Limited.

The term “core shell rubber” or CSR is being employed in accordance with its standard meaning in the art as denoting a rubber particle core formed by a polymer comprising an elastomeric or rubbery polymer as a main ingredient and a shell layer formed by a polymer which is graft polymerized onto the core. The shell layer partially or entirely covers the surface of the rubber particle core in the graft polymerization process. By weight, the core should constitute at least 50 wt. % of the core-shell rubber particle.

The polymeric material of the core should have a glass transition temperature (T_{g}) of no greater than 0° C. and preferably a glass transition temperature (T_{g}) of −20° C. or lower, more preferably −40° C. or lower and even more preferably −60° C. or lower. The polymer of the shell is non-elastomeric, thermoplastic or thermoset polymer having a glass transition temperature (T_{g}) of greater than room temperature, preferably greater than 30° C. and more preferably greater than 50° C.

Without intention to limit the invention, the core may be comprised of: a diene homopolymer, for example, a homopolymer of butadiene or isoprene; a diene copolymer, for example a copolymer of butadiene or isoprene with one or more ethylenically unsaturated monomers, such as vinyl aromatic monomers, (meth)acrylonitrile or (meth)acrylates; polymers based on (meth)acrylic acid ester monomers, such as polybutylacrylate; and, polysiloxane elastomers such as polydimethylsiloxane and crosslinked polydimethylsiloxane.

Similarly without intention to limit the present invention, the shell may be comprised of a polymer or copolymer of one or more monomers selected from: (meth)acrylates, such as methyl methacrylate; vinyl aromatic monomers, such as styrene; vinyl cyanides, such as acrylonitrile; unsaturated acids and anhydrides, such as acrylic acid; and, (meth)acrylamides. The polymer or copolymer used in the shell may possess acid groups that are cross-linked ionically through metal carboxylate formation, in particular through forming salts of divalent metal cations. The shell polymer or copolymer may also be covalently cross-linked by monomers having two or more double bonds per molecule.

It is preferred that any included core-shell rubber particles have an average particle size (d50) of from 10 nm to 300 nm, for example from 50 nm to 250 nm: said particle size refers to the diameter or largest dimension of a particle in a distribution of particles and is measured via dynamic light scattering. For completeness, the present application does not preclude the presence of two or more types of core shell rubber (CSR) particles with different particle size distributions in the composition to provide a balance of key properties of the resultant cured product, including shear strength, peel strength and resin fracture toughness.

The core-shell rubber may be selected from commercially available products, examples of which include: Paraloid EXL 2650A, EXL 2655 and EXL2691 A, available from The Dow Chemical Company; Clearstrength® XT100, available from Arkema Inc.; the Kane Ace® MX series available from Kaneka Corporation, and in particular MX 120, MX 125, MX 130, MX 136, MX 551, MX553; and, METABLEN SX-006 available from Mitsubishi Rayon.

The composition of the present invention may comprise electrically conductive particles. The composition may, for instance, contain from 0 to 10 wt. % or from 0.1 to 5 wt. % of electrically conductive particles, based on the weight of the composition.

Broadly, there is no particular intention to limit the shape of the particles employed as conductive fillers: particles that are acicular, spherical, ellipsoidal, cylindrical, bead-like, cubic or platelet-like may be used alone or in combination. Moreover, it is envisaged that agglomerates of more than one particle type may be used. Equally, there is no particular intention to limit the size of the particles employed as conductive fillers. However, such conductive fillers will conventionally have an average volume particle size, as measured by laser diffraction/scattering methods, of from 0.1 to 1500 μm, for example from 1 to 1250 μm.

Exemplary conductive particulate fillers include, but are not limited to: silver; copper; gold; palladium; platinum; nickel; gold or silver-coated nickel; carbon black; carbon fiber; graphite; aluminum; indium tin oxide; silver coated copper; silver coated aluminum; metallic coated glass spheres; metallic coated filler; metallic coated polymers; silver coated fiber; silver coated spheres; antimony doped tin oxide; conductive nanospheres; nano silver; nano aluminum; nano copper; nano nickel; carbon nanotubes; and, mixtures thereof. The use of particulate silver and/or carbon black as the conductive filler is preferred.

The composition of the present invention may optionally comprise electrically non-conductive filler. The composition may, for instance, contain from 0 to 10 wt. % or from 0.1 to 5 wt. % of electrically non-conductive particles, based on the weight of the composition.

Broadly, there is no particular intention to limit the shape of the particles employed as non-conductive fillers: particles that are acicular, spherical, ellipsoidal, cylindrical, bead-like, cubic or platelet-like may be used alone or in combination. Moreover, it is envisaged that agglomerates of more than one particle type may be used. Equally, there is no particular intention to limit the size of the particles employed as non-conductive fillers. However, such non-conductive fillers will conventionally have an average volume particle size, as measured by laser diffraction/scattering methods, of from 0.1 to 1500 μm, for example from 1 to 1250 μm.

Exemplary non-conductive fillers include but are not limited to calcium carbonate, calcium oxide, calcium hydroxide (lime powder), precipitated and/or pyrogenic silicic acid, zeolites, bentonites, wollastonite, magnesium carbonate, diatomite, barium sulfate, alumina, clay, talc, titanium oxide, iron oxide, zinc oxide, sand, quartz, flint, mica, glass beads, glass powder, and other ground mineral substances. Organic fillers can also be used, in particular wood fibers, wood flour, sawdust, cellulose, cotton, pulp, cotton, wood chips, chopped straw, chaff, ground walnut shells, and other chopped fibers. Short fibers such as glass fibers, glass filament, polyacrylonitrile, carbon fibers, Kevlar fibers, or polyethylene fibers can also be added.

The pyrogenic and/or precipitated silicic acids advantageously have a BET surface area from 10 to 90 m²/g. When they are used, they do not cause any additional increase in the viscosity of the composition according to the present invention, but do contribute to strengthening the cured composition.

It is likewise conceivable to use pyrogenic and/or precipitated silicic acids having a higher BET surface area, advantageously from 100 to 250 m²/g as a filler: because of the greater BET surface area, the effect of strengthening the cured composition is achieved with a smaller proportion by weight of silicic acid.

Also suitable as non-conductive fillers are hollow spheres having a mineral shell or a plastic shell. These can be, for example, hollow glass spheres that are obtainable commercially under the trade names Glass Bubbles®. Plastic-based hollow spheres, such as Expancel® or Dualite®, may be used and are described in EP 0 520 426 B1: they are made up of inorganic or organic substances and each have a diameter of 1 mm or less, preferably 500 μm or less.

Non-conductive fillers which impart thixotropy to the composition may be preferred for many applications: such fillers are also described as rheological adjuvants, e.g. hydrogenated castor oil, fatty acid amides, or swellable plastics such as PVC.

The desired viscosity of the curable composition formed may be determinative of the amount of filler used. Having regard to that latter consideration, the total amount of fillers—both electrically conductive and non-conductive—present in the compositions should not prevent the composition from being readily applicable by the elected method of application to the composition to a substrate. For example, curable compositions which are intended to be extrudable from a suitable dispensing apparatus, such as a tube, should possess a viscosity of from 1000 to 150,000, preferably from 10,000 to 100,000 mPas.

A “plasticizer” for the purposes of this invention is a substance that decreases the viscosity of the composition and thus facilitates its processability. Herein the plasticizer may constitute up to 10 wt. % or up to 5 wt. %, based on the total weight of the composition, and is preferably selected from the group consisting of: diurethanes; ethers of monofunctional, linear or branched C₄-C₁₆ alcohols, such as Cetiol OE (obtainable from Cognis Deutschland GmbH, Dosseldorf); esters of abietic acid, butyric acid, thiobutyric acid, acetic acid, propionic acid esters and citric acid; esters based on nitrocellulose and polyvinyl acetate; fatty acid esters; dicarboxylic acid esters; esters of OH-group-carrying or epoxidized fatty acids; glycolic acid esters; benzoic acid esters; phosphoric acid esters; sulfonic acid esters; trimellitic acid esters; polyether plasticizers, such as end-capped polyethylene or polypropylene glycols; polystyrene; hydrocarbon plasticizers; chlorinated paraffin; and, mixtures thereof. It is noted that, in principle, phthalic acid esters can be used as the plasticizer but these are not preferred due to their toxicological potential.

“Stabilizers” for purposes of this invention are to be understood as antioxidants, UV stabilizers, thermal stabilizers or hydrolysis stabilizers. Herein stabilizers may constitute in toto up to 10 wt. % or up to 5 wt. %, based on the total weight of the composition. Standard commercial examples of stabilizers suitable for use herein include: sterically hindered phenols; thioethers; benzotriazoles; benzophenones; benzoates; cyanoacrylates; acrylates; amines of the hindered amine light stabilizer (HALS) type; phosphorus; sulfur; and, mixtures thereof.

It is noted that compounds having metal chelating properties may be used in the compositions of the present invention to help enhance the adhesion of the cured adhesive to a substrate surface. Further, also suitable for use as adhesion promoters are the acetoacetate-functionalized modifying resins sold by King Industries under the trade name K-FLEX XM-B301.

In order to enhance shelf life even further, it is often advisable to further stabilize the compositions of the present invention with respect to moisture penetration through using drying agents. A need also occasionally exists to lower the viscosity of an adhesive composition according to the present invention for specific applications, by using reactive diluent(s). The total amount of reactive diluents present will typically be from 0 to 10 wt. %, for example from 0.1 to 5 wt. %, based on the total weight of the composition.

The presence of solvents and non-reactive diluents in the compositions of the present invention is also not precluded where this can usefully moderate the viscosities thereof. For instance, but for illustration only, the compositions may contain one or more of: xylene; 2-methoxyethanol; dimethoxyethanol; 2-ethoxyethanol; 2-propoxyethanol; 2-isopropoxyethanol; 2-butoxyethanol; 2-phenoxyethanol; 2-benzyloxyethanol; benzyl alcohol; ethylene glycol; ethylene glycol dimethyl ether; ethylene glycol diethyl ether; ethylene glycol dibutyl ether; ethylene glycol diphenyl ether; diethylene glycol; diethylene glycol-monomethyl ether; diethylene glycol-monoethyl ether; diethylene glycol-mono-n-butyl ether; diethylene glycol dimethyl ether; diethylene glycol diethyl ether; diethylene glycoldi-n-butylyl ether; propylene glycol butyl ether; propylene glycol phenyl ether; dipropylene glycol; dipropylene glycol monomethyl ether; dipropylene glycol dimethyl ether; dipropylene glycoldi-n-butyl ether; N-methylpyrrolidone; diphenylmethane; diisopropylnaphthalene; petroleum fractions such as Solvesso® products (available from Exxon); alkylphenols, such as tert-butylphenol, nonylphenol, dodecylphenol and 8,11,14-pentadecatrienylphenol; styrenated phenol; bisphenols; aromatic hydrocarbon resins especially those containing phenol groups, such as ethoxylated or propoxylated phenols; adipates; sebacates; phthalates; benzoates; organic phosphoric or sulfonic acid esters; and sulfonamides.

The above aside, it is preferred that said non-reactive diluents constitute in toto less than 10 wt. %, in particular less than 5 wt. % or less than 2 wt. %, based on the total weight of the composition.

### Methods and Applications

To form a composition, the above described parts are brought together and mixed. It is important that the mixing homogenously distributes the polymerizable electrolyte—compounds b1) and/or b2)—within the adhesive composition: such thorough and effective mixing can be determinative of a homogeneous distribution of the charged species within the polymer matrix obtained following curing and thereby of the provision of sufficient ionic conductivity to support an electrochemical reaction at the interface with the electrically conductive substrate.

As is known in the art, to form one component (1K) curable compositions, the elements of the composition are brought together and homogeneously mixed under conditions which inhibit or prevent the reactive components from reacting: such conditions would be readily comprehended by the skilled artisan. As such, it will often be preferred that the curative elements are not mixed by hand but are instead mixed by machine—a static or dynamic mixer, for example—in pre-determined amounts under anhydrous conditions without intentional photo-irradiation.

For the two component (2K) compositions, the reactive components are brought together and mixed in such a manner as to induce the hardening thereof. For both one (1K) and two (2K) component compositions, the reactive compounds should be mixed under sufficient shear forces to yield a homogeneous mixture. It is considered that this can be achieved without special conditions or special equipment. That said, suitable mixing devices might include: static mixing devices; magnetic stir bar apparatuses; wire whisk devices; augers; batch mixers; planetary mixers; C.W. Brabender or Banburry® style mixers; and, high shear mixers, such as blade-style blenders and rotary impellers.

For small-scale liner applications in which volumes of less than 2 liters will generally be used, the preferred packaging for two component (2K) compositions will be side-by-side double cartridges or coaxial cartridges, in which two tubular chambers are arranged alongside one another or inside one another and are sealed with pistons: the driving of these pistons allows the components to be extruded from the cartridge, advantageously through a closely mounted static or dynamic mixer. For larger volume applications, the two components of the composition may advantageously be stored in drums or pails: in this case the two components are extruded via hydraulic presses, in particular by way of follower plates, and are supplied via pipelines to a mixing apparatus which can ensure fine and highly homogeneous mixing of the hardener and binder components. In any event, for any package it is important that the binder component be disposed with an airtight and moisture-tight seal, so that both components can be stored for a long time, ideally for 12 months or longer.

Non-limiting examples of two component dispensing apparatuses and methods that may be suitable for the present invention include those described in U.S. Pat. Nos. 6,129,244 and 8,313,006.

Where applicable, two (2K) component compositions should broadly be formulated to exhibit an initial viscosity—determined immediately after mixing, for example, up to two minutes after mixing—which is not prohibitive of the method by which the composition is to be applied to a substrate. Moreover, the two component (2K) composition should further be formulated to demonstrate a pot life of at least 30 minutes and commonly of at least 60 or 120 minutes, which “pot life” is the time required for the viscosity of the curable composition to reach a value that is 2 times the viscosity of the freshly-mixed curable composition at 20° C. and 50% relative humidity.

In accordance with the broadest process aspects of the present invention, the above described compositions are applied to a substrate and then cured in situ. Prior to applying the compositions, it is often advisable to pre-treat the relevant surfaces to remove foreign matter there from: this step can, if applicable, facilitate the subsequent adhesion of the compositions thereto. Such treatments are known in the art and can be performed in a single or multi-stage manner constituted by, for instance, the use of one or more of: an etching treatment with an acid suitable for the substrate and optionally an oxidizing agent; sonication; plasma treatment, including chemical plasma treatment, corona treatment, atmospheric plasma treatment and flame plasma treatment; immersion in a waterborne alkaline degreasing bath; treatment with a waterborne cleaning emulsion; treatment with a cleaning solvent, such as carbon tetrachloride or trichloroethylene; and, water rinsing, preferably with deionized or demineralized water. In those instances where a waterborne alkaline degreasing bath is used, any of the degreasing agent remaining on the surface should desirably be removed by rinsing the substrate surface with deionized or demineralized water.

In some embodiments, the adhesion of the coating compositions of the present invention to the preferably pre-treated substrate may be facilitated by the application of a primer thereto. Whilst the skilled artisan will be able to select an appropriate primer, instructive references for the choice of primer include but are not limited to: U.S. Pat. Nos. 3,671,483; 4,681,636; 4,749,741; 4,147,685; and, U.S. Pat. No. 6,231,990.

The compositions are then applied to the preferably pre-treated, optionally primed surfaces of the substrate by conventional application methods such as: brushing; roll coating using, for example, a 4-application roll equipment where the composition is solvent-free or a 2-application roll equipment for solvent-containing compositions; doctor-blade application; printing methods; and, spraying methods, including but not limited to air-atomized spray, air-assisted spray, airless spray and high-volume low-pressure spray.

As noted above, the present invention provides a bonded structure comprising: a first material layer having an electrically conductive surface; and, a second material layer having an electrically conductive surface, wherein the cured electrochemically debondable adhesive composition as defined hereinabove and in the appended claims is disposed between said first and second material layers. To produce such a structure, the adhesive composition may be applied to at least one internal surface of the first and/or second material layer and the two layers then subsequently contacted, optionally under the application of pressure, such that the electrically debondable adhesive composition is interposed between the two layers.

It is recommended that the compositions be applied to a surface at a wet film thickness of from 10 to 5000 μm, for example from 50 to 2500 μm. The application of thinner layers within this range is more economical and provides for a reduced likelihood of deleterious thick cured regions. However, great control must be exercised in applying thinner coatings or layers so as to avoid both the formation of discontinuous cured films and short contacts.

The curing of the applied compositions of the invention typically occurs at temperatures in the range of from 40° C. to 200° C., preferably from 50° C. to 190° C., and in particular from 60° C. to 180° C. The temperature that is suitable depends on the specific compounds present and the desired curing rate and can be determined in the individual case by the skilled artisan, using simple preliminary tests if necessary. Of course, curing at lower temperatures within the aforementioned ranges is advantageous as it obviates the requirement to substantially heat or cool the mixture from the usually prevailing ambient temperature. Where applicable, however, the temperature of the mixture formed from the respective elements of the composition may be raised above the mixing temperature and/or the application temperature using conventional means including microwave induction.

The present invention will be described with reference to the appended drawings in which:

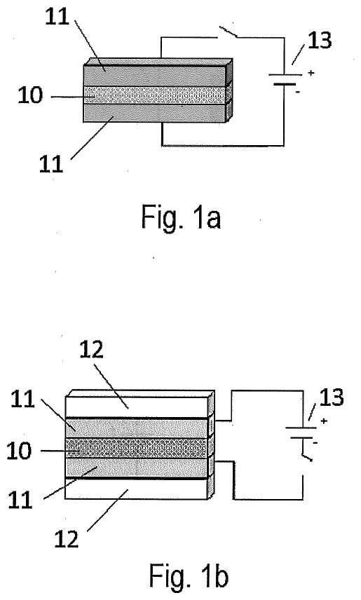

FIG. 1a depicts a bonded structure in accordance with a first embodiment of the present invention.

FIG. 1b depicts a bonded structure in accordance with a second embodiment of the present invention.

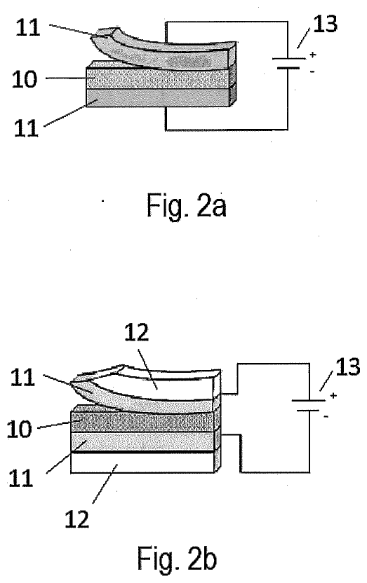

FIG. 2a depicts the initial debonding of the structure of the first embodiment upon application of a voltage across that structure.

FIG. 2b depicts the initial debonding of the structure of the second embodiment upon application of a voltage across that structure.

As shown in FIG. 1a appended hereto, a bonded structure is provided in which a layer of cured adhesive (10) is disposed between two conductive substrates (11). A layer of non-conductive material (12) may be disposed on the conductive substrates (11) to form the more complex bonded structure as depicted in FIG. 1b. Each layer of conductive substrate (11) is in electrical contact with an electrical power source (13) which may be a battery or an AC-driven source of direct current (DC). The positive and negative terminals of that power source (13) are shown in one fixed position but the skilled artisan will of course recognize that the polarity of the system can be reversed.

The two conductive substrates (11) are shown in the form of a layer which may be constituted by inter alia: a metallic film; a metallic mesh or grid; deposited metal particles; a resinous material which is rendered conductive by virtue of conductive elements disposed therein; or, a conducting oxide layer. As exemplary conductive elements there may be mentioned silver filaments, single-walled carbon nanotubes and multi-walled carbon nanotubes. As exemplary conducting oxides there may be mentioned: doped indium oxides, such as indium tin oxide (ITO); doped zinc oxide; antimony tin oxide; cadmium stannate; and, zinc stannate. The selection of the conductive material aside, the skilled artisan will recognize that the efficacy of the debonding operation may be diminished where the conductive substrates (11) are in the form of a grid or mesh which offers limited contact with the layer of cured adhesive (10).

When an electrical voltage is applied between each conductive substrate (11), current is supplied to the adhesive composition (10) disposed there between. This induces electrochemical reactions at the interface of the substrates (11) and the adhesive composition, which electrochemical reactions are understood as oxidative at the positively charged or anodic interface and reductive at the negatively charged or cathodic interface. The reactions are considered to weaken the adhesive bond between the substrates allowing the easy removal of the debondable composition from the substrate.

As depicted in FIGS. 2a and 2b for illustrative purposes only, the debonding occurs at the positive interface, that interface between the adhesive composition (10) and the electrically conductive surface (11) that is in electrical contact with the positive electrode. By reversing current direction prior to separation of the substrates, the adhesive bond may be weakened at both substrate interfaces.

It is however noted that the composition of the adhesive layer (10) may be moderated so that debonding occurs at either the positive or negative interface or simultaneously from both. For some embodiments, a voltage applied across both surfaces so as to form an anodic interface and a cathodic interface will cause debonding to occur simultaneously at both the anodic and cathodic adhesive/substrate interfaces. In an alternative embodiment, reversed polarity may be used to simultaneously disbond both substrate/adhesive interfaces if the composition does not respond at both interfaces to direct current. The current can be applied with any suitable waveform, provided that sufficient total time at each polarity is allowed for debonding to occur. Sinusoidal, rectangular and triangular waveforms might be appropriate in this regard and may be applied from a controlled voltage or a controlled current source.

Without intention to limit the present invention, it is considered that the debonding operation may be performed effectively where at least one and preferably both of the following conditions are instigated: a) an applied voltage of from 1 to 100 V, for example from 20 to 50 V; and, b) the voltage being applied for a duration of from 1 second to 180 minutes, for example from 1 second to 30 minutes. Where the release of the conductive substrate from the cured adhesive is to be facilitated by the application of a force—exerted via a weight or a spring, for instance—the potential might only need to be applied in the order of seconds.

The following examples are illustrative of the present invention and are not intended to limit the scope of the invention in any way.

### EXAMPLES

The following materials and abbreviations for said materials were employed in the Examples:
MMA: Methyl methacrylate
MAA: Methacrylic acid
EGDMA: Ethylene glycol dimethylacrylate
PEG-MEA: Polyethylene glycol methyl ether acrylate
BENZYL MA: Benzyl methacrylate
HEMA: (Hydroxyethyl)methacrylate
IBOA: Isobornyl acrylate
AIBN: Azobisisobutyronitrile, available from Sigma Aldrich
BPO: Benzoyl peroxide, available from PanReac AppliChem
HEXMIM StSO3: 1H-Imidazolium, 3-methyl-1-hexyl-4-ethenylbenzenesulfonate
EMIM Acrylate: 1H-Imidazolium, 1-ethyl-3-methyl-acrylate
ViEIM NTf2: 1H-Imidazolium, 3-ethenyl-1-ethyl-1,1,1-trifluoro-N-[(trifluoromethyl) sulfonyl]methanesulfonamide
BMIM NTf2: 1H-Imidazolium, 3-methyl-1-butyl-1,1,1-trifluoro-N-[(trifluoromethyl) sulfonyl]methanesulfonamide
PEG400: Polyethylene glycol, available from Sigma Aldrich.
CN966H90: An aliphatic polyester based urethane diacrylate oligomer blended with 10% 2(2-ethoxyethoxy) ethyl acrylate, available from Sartomer
SR9054: An acid acrylate adhesion promoter, available from Sartomer

Preparation of a first set of Formulations: The formulations EDA1 to EDA14 plus the Controls 1, 2 and 3 are described in Table 1a & 1b herein below were formed under mixing.

TABLE 1a

| | Control 1 | EDA1 | EDA2 | EDA3 | EDA4 | EDA5 | EDA6 | EDA7 | EDA8 |
|---|---|---|---|---|---|---|---|---|---|
| Ingredient | (g) | (g) | (g) | (g) | (g) | (g) | (g) | (g) | (g) |
| MMA | 0.780 | 0.780 | 0.780 | 0.780 | 0.780 | 0.780 | 0.780 | 0.780 | 0.780 |
| MAA | 0.100 | 0.100 | 0.100 | 0.100 | 0.100 | 0.100 | 0.100 | 0.100 | 0.100 |
| EGDMA | 0.020 | 0.020 | 0.020 | 0.020 | 0.020 | 0.020 | 0.020 | 0.020 | 0.020 |
| PEG-MEA | 0.100 | 0.100 | 0.100 | 0.100 | 0.100 | 0.100 | 0.100 | 0.100 | 0.100 |
| AIBN | 0.061 | 0.073 | 0.073 | 0.077 | 0.069 | 0.065 | 0.069 | 0.069 | 0.061 |
| HEXMIM StSO3 | | 0.623 | | 0.208 | 0.104 | 0.052 | 0.208 | 0.312 | |
| | | (1.78 | | (0.59 | (0.30 | (0.15 | (0.59 | (0.89 | |
| | | mmol) | | mmol) | mmol) | mmol) | mmol) | mmol) | |
| ViEIM NTf2 | | | 0.717 | 0.717 | 0.359 | 0.180 | 0.240 | 0.120 | |
| | | | (1.78 | (1.78 | (0.89 | (0.44 | (0.59 | (0.30 | |
| | | | mmol) | mmol) | mmol) | mmol) | mmol) | mmol) | |
| Copolymer PE | | | | | | | | | 0.463 |
| | | | | | | | | | (1.16 |
| | | | | | | | | | mmol) |

TABLE 1b

| | EDA9 | EDA10 | EDA11 | EDA12 | Control 2 | EDA13 | Control 3 | EDA14 |
|---|---|---|---|---|---|---|---|---|
| Ingredient | (g) | (g) | (g) | (g) | (g) | (g) | (g) | (g) |
| MMA | 0.780 | 0.780 | 0.780 | 0.780 | | | 0.630 | 0.630 |
| MAA | 0.100 | 0.100 | 0.100 | 0.100 | 0.100 | 0.100 | 0.100 | 0.100 |
| EGDMA | 0.020 | 0.020 | 0.020 | 0.020 | 0.020 | 0.020 | 0.020 | 0.020 |
| PEG-MEA | 0.100 | 0.100 | 0.100 | 0.100 | 0.100 | 0.100 | 0.100 | 0.100 |
| BENZYL MA | | | | | 0.780 | 0.780 | 0.150 | 0.150 |
| AIBN | 0.061 | 0.061 | 0.061 | 0.073 | 0.039 | 0.047 | 0.057 | 0.065 |
| HEXMIM StSO3 | 0.052 | 0.052 | 0.052 | | | 0.105 | | 0.105 |
| | (0.15 | (0.15 | (0.15 | | | | | |
| | mmol) | mmol) | mmol) | | | | | |
| ViEIM NTf2 | 0.179 | 0.179 | 0.179 | | | 0.359 | | 0.359 |
| | (0.44 | (0.44 | (0.44 | | | | | |
| | mmol) | mmol) | mmol) | | | | | |
| BMIM NTf2 | | | 0.012 | 0.20 | | | | |
| Carbon Black | 0.012 | | | | | | | |
| PEG-400 | | 0.012 | | | | | | |

The bracketed amounts given in Table 1a & 1b for the polymerizable electrolyte are in millimoles (mmol).

The Controls 1, 2 and 3 are constituted by the non-ionic matrix monomers that form the adhesive without any ionic species. Formulations EDA1 to EDA7, EDA9 to EDA11 and EDA13 to EDA14 are based on the copolymerization of the non-ionic matrix monomers with polymerizable ionic compounds.

EDA8 is a blend of the non-ionic matrix monomers and a cured polymerizable electrolyte (PE) copolymer and was obtained in the following way: first, ViEIM NTf2 (0.359 g) and HexMIM StSO3 (0.104 g) were speed-mixed with azobisisobutyronitrile (0.008 g) at 3600 rpm for one minute; the mixture was then cured for 15 minutes at 80° C. followed by 2 hours at 120° C.; and, finally, the cured material was mixed with the non-ionic matrix monomers and azobisisobutyronitrile.

EDA12 forms a reference and is based on a mixture of the non-ionic matrix monomers with a non-polymerizable ionic compound (BMIM NTf2).

The application substrate for the following Formulations EDA1 to EDA14 and the Controls was aluminium (AA6016) having a thickness of 1.25 mm and application of the coating composition was performed using glass beads having a diameter of from 100 to 200 microns as spacers. The substrate was cut into samples of 2.5 cm×10 cm in size for tensile testing. Tensile lap shear (TLS) test was performed at room temperature based upon ISO 4587 Adhesives—Determination of tensile lap-shear strength of rigid-to-rigid bonded assemblies (International Organization for Standardization, 2003). The bond overlapping area for each stated substrate was 2.5 cm×1.0 cm with a bond thickness of 0.1 cm (40 mil). An INSTRON 3366 with a 10 kN cell was employed.

The applied adhesive compositions were cured in the overlapping region by the application of a temperature of 80° C. for 15 minutes and 120° C. for 120 minutes. The bonded structures were then stored at room temperature for 24 hours prior to initial tensile testing.

### Example 1

Tensile lap shear strength was investigated after said 24 hour storage period both prior and subsequent to the application of a constant potential of 50 V across the adhesive layer for a duration of 30 minutes. The results are documented in Table 2 herein below.

TABLE 2

| | Initial Bond Strength | Bond Strength after |
|---|---|---|
| Adhesive | (MPa) | 50 V, 30 minutes (MPa) |
| Control 1 | 2.03 (±0.59) | 2.11 (±0.28) |
| EDA1 | 3.67 (±0.56) | 3.15 (±0.06) |
| EDA2 | 2.18 (±0.36) | 1.48 (±0.20) |
| EDA3 | 3.44 (±0.31) | 0 |
| EDA4 | 3.07 (±0.58) | 0.71 (±0.62) |
| EDA5 | 2.63 (±0.51) | 1.10 (±0.23) |
| EDA6 | 2.66 (±0.34) | 1.71 (±0.12) |
| EDA7 | 3.85 (±0.71) | 2.80 (±0.63) |
| EDA8 | 2.09 (±0.13) | 2.08 (±0.33) |
| EDA9 | 2.61 (±0.09) | 0.97 (±0.09) |
| EDA10 | 1.98 (±0.41) | 0 |
| EDA11 | 2.35 (±0.11) | 0 |
| EDA12 | 1.60 (±0.60) | 0 |
| (Reference) | | |
| Control 2 | 1.76 (+0.77) | 1.17 (±0.61) |
| EDA13 | 2.60 (±0.54) | 1.54 (±0.12) |
| Control 3 | 1.53 (±0.63) | 2.32 (±0.45) |
| EDA14 | 2.67 (±0.86) | 0 |

Formulations containing polymerizable ionic compounds increase the initial adhesive strength. The bond strength of formulations based on the copolymerization of polymerizable ionic compounds and the non-ionic matrix monomers decreases after applying a voltage.

### Example 2

This example investigates the electro-delamination behavior of the afore-described adhesive formulation EDA5 by measurement of tensile lap shear strength after said 24 hour storage period both prior to and subsequent to the application of different constant potentials across the adhesive layer for a duration of 30 minutes. The results are documented in Table 3 herein below.

TABLE 3

| | Initial Bond | Bond Strength after | Bond Strength after | Bond Strength after |
|---|---|---|---|---|
| | Strength | 20 V, 30 minutes | 50 V, 30 minutes | 80 V, 30 minutes |
| Adhesive | (MPa) | (MPa) | (MPa) | (MPa) |
| Control | 2.03 (±0.59) | | 2.11 (±0.28) | |
| EDA5 | 2.63 (±0.51) | 1.59 (±0.22) | 1.10 (±0.23) | 0 |

### Example 3

This example investigates the electro-delamination behaviour of certain of the afore-described adhesives by measurement of tensile lap shear strength after said 24 hour storage period and after a 2 month storage period both prior and subsequent to the application of a constant potential of 50 V across the adhesive layer for a duration of 30 minutes. The results are documented in Table 4 herein below.

TABLE 4

| | | | | Bond Strength after |
|---|---|---|---|---|
| | Initial Bond | Bond Strength after | Bond Strength after | 2 Months Aging |
| | Strength | 50 V, 30 minutes | 2 Months Aging | 50 V, 30 minutes |
| Adhesive | (MPa) | (MPa) | (MPa) | (MPa) |
| Control | 2.03 (±0.59) | 2.11 (±0.28) | | |
| EDA5 | 2.63 (±0.51) | 1.10 (±0.23) | 2.34 (±0.03) | 0.97 (±0.42) |
| EDA11 | 2.35 (±0.11) | 0 | 2.30 (±0.26) | 0 |
| EDA12 | 1.60 (±0.60) | 0 | 0 | 0 |
| (Reference) | | | | |

Formulations based on the copolymerization of the non-ionic matrix monomers with polymerizable ionic compounds maintain the initial bond strength after two months and still show a decrease of the bond strength after applying a voltage.

Preparation of a second set of Formulations: The formulations EDA15 to EDA19 plus the Control 4 are described in Table 5 herein below were formed under mixing.

TABLE 5

| | Control 4 | EDA15 | EDA16 | EDA17 | EDA18 | Reference EDA19 |
|---|---|---|---|---|---|---|
| Ingredient | (g) | (g) | (g) | (g) | (g) | (g) |
| CN966H90 | 0.600 | 0.600 | 0.600 | 0.600 | 0.600 | 0.600 |
| HEMA | 0.340 | 0.340 | | 0.340 | 0.340 | 0.340 |
| IBOA | | | 0.340 | | | |
| SR9054 | 0.060 | 0.060 | 0.060 | 0.060 | 0.060 | 0.060 |
| BPO | 0.040 | 0.040 | 0.040 | 0.040 | 0.040 | 0.040 |
| HEXMIM StSO3 | | 0.208 | 0.208 | | 0.312 | |
| EMIM Acrylate | | | | 0.108 | | |
| ViEIM NTf2 | | 0.717 | 0.717 | 0.717 | | |
| ViEIM MMS | | | | | 0.760 | |
| BMIM NTf2 | | | | | | 0.231 |

The Control 4 is constituted by the non-ionic matrix monomers that form the adhesive without any ionic species. Formulations EDA15 to EDA18 are based on the copolymerization of the non-ionic matrix monomers with polymerizable ionic compounds.

EDA19 forms a reference and is based on a mixture of the non-ionic matrix monomers with a non-polymerizable ionic compound (BMIM NTf2).

The application substrate for the following Formulations EDA15 to EDA19 and Control 4 was aluminium (AA6016) having a thickness of 1.25 mm and stainless steel (1.4301) having a thickness of 1.5 mm and application of the coating composition was performed using glass beads having a diameter of from 100 to 200 microns as spacers. The substrate was cut into samples of 2.5 cm×10 cm (1″×4″) in size for tensile testing. Tensile lap shear (TLS) test was performed at room temperature based upon ISO 4587 Adhesives—Determination of tensile lap-shear strength of rigid-to-rigid bonded assemblies (International Organization for Standardization, 2003). The bond overlapping area for each stated substrate was 2.5 cm×1.0 cm with a bond thickness of 0.1 cm (40 mil). A Zwick Z020 with a 20 kN cell was employed.

The applied adhesive compositions were cured in the overlapping region by the application of a temperature of 80° C. for 15 minutes and 120° C. for 30 minutes. The bonded structures were then stored at room temperature for 24 hours prior to initial tensile testing.

### Example 4

Tensile lap shear strength was investigated after said 24 hour storage period both prior and subsequent to the application of a constant potential of 50 V across the adhesive layer for a duration of 30 minutes. The results are documented in Table 6 herein below.

TABLE 6

| | Aluminium | | | Stainless Steel | |
|---|---|---|---|---|---|
| | Initial Bond | | Bond Strength after | Initial Bond | Bond Strength after |
| | Strength | | 50 V, 30 minutes | Strength | 50 V, 30 minutes |
| Adhesive | (MPa) | | (MPa) | (MPa) | (MPa) |
| Control 4 | 11.02 | (±0.39) | 11.19 (±0.46) | 11.05 (±0.54) | 10.58 (±0.10) |
| EDA15 | 12.38 | (±0.64) | 0 | 9.19 (±1.03) | 0 |
| EDA16 | 9.76 | (±0.17) | 4.39 (±0.12) | Not tested | Not tested |
| EDA17 | 5.82 | (±0.14) | 0 | Not tested | Not tested |
| EDA18 | 10.54 | (±0.04) | 2.86 (±0.03) | Not tested | Not tested |
| EDA19 | 6.03 | (±0.39) | 0 | 6.46 (±0.62) | 0 |

Formulations EDA15 and EDA18 containing polymerizable ionic compounds maintains the initial adhesive strength, while formulation EDA17 saw a drop in initial strength. Formulation EDA19 containing a non-polymerizable ionic liquid sees a drop in initial strength by 50%. The bond strength of formulations based on the copolymerization of polymerizable ionic compounds and the non-ionic matrix monomers decreases after applying a voltage.

### Example 5

This example investigates the electro-delamination behavior of certain of the afore-described adhesives (EDA15 in comparison with EDA19) by measurement of tensile lap shear strength after said 24 hour storage period and after 1 week, 1 month, 2 months and 3 months storage period both prior and subsequent to the application of a constant potential of 50 V across the adhesive layer for a duration of 30 minutes. A climatized chamber was used set to 23° C. and 50% relative humidity. The results are documented in Tables 7 and 8 herein below.

TABLE 7
Aluminium

| | | | EDA19 | |
|---|---|---|---|---|
| | EDA15 | | | Bond Strength after |
| | Initial Bond | Bond Strength after | Bond Strength after | 2 Months Aging |
| | Strength | 50 V, 30 minutes | 2 Months Aging | 50 V, 30 minutes |
| Storage Time | (MPa) | (MPa) | (MPa) | (MPa) |
| Initial | 12.38 (±0.64) | 0 | 6.03 (±0.39) | 0 |
| 1 week | 12.45 (±0.56) | 0 | 5.83 (±0.38) | 0 |
| 1 month | 10.00 (±0.88) | 0 | 4.48 (±0.95) | 0 |
| 2 months | 10.94 (±0.20) | 0 | 4.18 (±0.16) | 0 |
| 3 months | 11.03 (±1.43) | 0 | Not tested | Not tested |

TABLE 8
Stainless Steel

| | | | EDA19 | |
|---|---|---|---|---|
| | EDA15 | | | Bond Strength after |
| | Initial Bond | Bond Strength after | Bond Strength after | 2 Months Aging |
| | Strength | 50 V, 30 minutes | 2 Months Aging | 50 V, 30 minutes |
| Storage Time | (MPa) | (MPa) | (MPa) | (MPa) |
| Initial | 9.19 (±1.03) | 0 | 6.46 (±0.62) | 0 |
| 1 week | 9.38 (±0.69) | 0 | 5.46 (±0.33) | 0 |
| 1 month | 9.09 (±1.75) | 0 | 4.25 (±0.30) | 0 |
| 2 months | 8.51 (±0.51) | 0 | 4.58 (±0.21) | 0 |
| 3 months | 8.13 (±0.28) | 0 | Not tested | Not tested |

Formulation EDA15 based on the copolymerization of the non-ionic matrix monomers with polymerizable ionic compounds show a slight decrease in bond strength after three months (12%). Formulation based on the mixture of a non-polymerizable ionic liquid and non-ionic matrix monomers show a higher decrease in bond strength after two months of 30% for both aluminium and stainless steel. All formulations show a decrease of the bond strength after applying a voltage.

In view of the foregoing description and examples, it will be apparent to those skilled in the art that equivalent modifications thereof can be made without departing from the scope of the claims.

What is claimed is:

1. A curable and electrochemically debondable adhesive composition comprising, based on the weight of the composition:
from 40 to 99 wt. % of a) at least one ethylenically unsaturated non-ionic monomer;
from 0.9 to 50 wt. % of b) at least one polymerizable ionic compound, wherein said polymerizable ionic compound comprises:
b1) at least one compound in accordance with general formula IV: 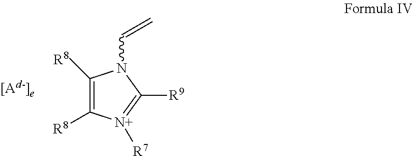
and/or
b2) at least one compound in accordance with general formula V: 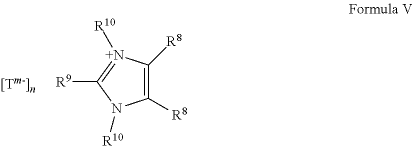
wherein: R⁷ is selected from: C₁-C₃₀ alkyl; C₂-C₈ alkenyl; C₁-C₃₀ heteroalkyl; C₃-C₃₀ cycloalkyl; C₆-C₁₈ aryl; C₁-C₉ heteroaryl; C₇-C₁₈ alkylaryl; C₂-C₅ heterocycloalkyl; or, —R^{a}—C(═O)—R^{b} where R^{a} is a C₁-C₆ alkylene group and R^{b} is a C₁-C₆ alkyl group;
each R^{a} is independently selected from H, C₁-C₁₈ alkyl, C₁-C₁₈ heteroalkyl; C₃-C₁₈ cycloalkyl, C₆-C₁₈ aryl, C₁-C₉ heteroaryl, C₇-C₁₈ alkylaryl; or, C₂-C₅ heterocycloalkyl;
R⁹ is H or C₁-C₄ alkyl;
each R¹⁰ is independently selected from: C₁-C₃₀ alkyl; C₁-C₃₀ heteroalkyl; C₃-C₃₀ cycloalkyl; C₆-C₁₈ aryl; C₁-C₉ heteroaryl; C₇-C₁₈ alkylaryl; C₂-C₅ heterocycloalkyl; or, —R^{a}—C(═O)—R^{b} where R^{a} is a C₁-C₆ alkylene group and R^{b} is a C₁-C₆ alkyl group;
A is a non-polymerizable anion;
T is an ethylenically unsaturated anion;
d and m are each integers having a value of at least 1;
e and n have a numeric value such that the compound is electrically neutral; and, [symbol]
is a covalent bond, C₁-C₂ alkylene, —CH₂OC(═O)—, —CH₂CH₂OC(═O)—, p-benzyl or p-tolyl; and,
from 0.1 to 10 wt. % of c) at least one free radical initiator.

2. The adhesive composition according to claim 1 comprising:
from 45 to 95 wt. % of a) said at least one ethylenically unsaturated non-ionic monomer;
from 5 to 30 wt. % of b) said at least one polymerizable ionic compound;
from 0.1 to 5 wt. % of c) said at least one free radical initiator; and,
from 0 to 10 wt. % of d) solubilizer.

3. The adhesive composition according to claim 1, wherein part a) comprises from 40 to 95 wt. %, based on the weight of the composition, of a1) at least one (meth)acrylate monomer represented by Formula I:
H₂C=CGCO₂R¹ (I)
wherein: G is hydrogen, halogen or a C₁-C₄ alkyl group; and,
R¹ is selected from: C₁-C₃₀ alkyl; C₂-C₃₀ heteroalkyl; C₃-C₃₀ cycloalkyl; C₂-C₈ heterocycloalkyl; C₂-C₂₀ alkenyl; and, C₂-C₁₂ alkynyl.

4. The adhesive composition according to claim 1, wherein part a) comprises comprises up to 50 wt. % based on the weight of the composition, of a3) at least one (meth)acrylate-functionalized oligomer.

5. The adhesive composition according to claim 1, wherein part a) comprises at least one α,β-ethylenically unsaturated monocarboxylic acid having from 3 to 5 carbon atoms.

6. The adhesive composition according to claim 1, wherein in part b):
R⁷ is selected from C₁-C₈ alkyl; C₂-C₄ alkenyl; C₁-C₈ heteroalkyl; C₃-C₁₂ cycloalkyl; C₆-C₁₈ aryl; C₁-C₉ heteroaryl; C₇-C₁₈ alkylaryl; C₂-C₅ heterocycloalkyl; or, —R^{a}—C(═O)—R^{b} where R^{a} is a C₁-C₄ alkylene group and R^{b} is a C₁-C₄ alkyl group;
each R⁸ is independently selected from H or C₁-C₂ alkyl;
R⁹ is H or methyl; and,
R¹⁰ is selected from C₁-C₈ alkyl; C₁-C₈ heteroalkyl; C₃-C₁₂ cycloalkyl; C₆-C₁₈ aryl; C₁-C₉ heteroaryl; C₇-C₁₈ alkylaryl; C₂-C₅ heterocycloalkyl; or, —R^{a}—C(═O)—R^{b} where R^{a} is a C₁-C₄ alkylene group and R^{b} is a C₁-C₄ alkyl group.

7. The adhesive composition according to claim 1, wherein part b) comprises:
b1) at least one compound selected from the group consisting of: 1H-Imidazolium, 3-ethenyl-1-methyl-, iodide; 1H-Imidazolium, 3-ethenyl-1-methyl-, chloride; 1H-Imidazolium, 3-ethenyl-1-methyl-, bromide; 1H-Imidazolium, 3-ethenyl-1-methyl-, methanesulfonate; 1H-Imidazolium, 3-ethenyl-1-methyl-, 1,1,1-trifluoro-N-[(trifluoromethyl)sulfonyl]methanesulfonamide; 1H-Imidazolium, 3-ethenyl-1-ethyl-, 1,1, 1-trifluoro-N-[(trifluoromethyl)sulfonyl]methanesulfonamide; 1H-Imidazolium, 3-ethenyl-1-methyl-, hexafluorophosphate; 1H-Imidazolium, 3-ethenyl-1-methyl-, 4-methylbenzenesulfonate; 1H-Imidazolium, 3-ethenyl-1-methyl-, tetrafluoroborate; 1H-Imidazolium, 3-ethenyl-1-ethyl-, iodide; 1H-Imidazolium, 3-ethenyl-1-ethyl-, bromide; 1H-Imidazolium, 3-ethenyl-1-ethyl-, 1,1,1-trifluoro-N-[(trifluoromethyl)sulfonyl]methanesulfonamide; 1H-Imidazolium, 3-ethenyl-1-ethyl-, hexafluorophosphate; 1H-Imidazolium, 3-ethenyl-1-ethyl-, tetrafluoroborate; 1H-Imidazolium, 3-ethenyl-1-(1-methylethyl)-, bromide; 1H-Imidazolium, 3-(1,1-dimethylethyl)-1-ethenyl-, bromide; 1H-Imidazolium, 3-ethenyl-1-propyl-, bromide; 1H-Imidazolium, 3-ethenyl-1-(phenylmethyl)-, bromide; 1H-Imidazolium, 1-ethenyl-3-(4-methylphenyl)-, chloride; 1H-Imidazolium, 3-ethenyl-1-(1-methylpropyl)-, chloride; 1H-Imidazolium, 1-butyl-3-ethenyl-, bromide; 3-[(4-ethenylphenyl)methyl]-1-methyl-, iodide; 1H-Imidazolium, 3-[(4-ethenylphenyl) methyl]-1-methyl-, chloride; 1H-Imidazolium, 3-[(4-ethenylphenyl)methyl]-1-methyl-, 1,1, 1-trifluoro-N-[(trifluoromethyl)sulfonyl]methanesulfonamide; 1H-Imidazolium, 3-[(4-ethenylphenyl)methyl]-1-methyl-, hexafluorophosphate; 1H-Imidazolium, 3-[(4-ethenylphenyl)methyl]-1-methyl-, tetrafluoroborate; 1H-Imidazolium, 3-[(4-ethenylphenyl)methyl]-1-ethyl-, chloride; 1H-Imidazolium, 1-[(4-ethenylphenyl)methyl]-3-ethyl-, salt with 1,1,1-trifluoro-N-[(trifluoromethyl)sulfonyl]methanesulfonamide; 1H-Imidazolium, 1-(3-aminopropyl)-3-[(4-ethenylphenyl)methyl]-, chloride; 1H-Imidazolium, 1-butyl-3-[(4-ethenylphenyl)methyl]-, chloride; and/or
b2) at least one compound selected from the group consisting of: 1H-Imidazolium, 1-methyl-3-hexyl-, 4-ethenylbenzenesulfonate; 1H-Imidazolium, 1-dodecyl-3-ethenyl-, 4-ethenylbenzenesulfonate; 1H-Imidazolium, 1-methyl-3-propyl-, 4-ethenylbenzenesulfonate; and, 1H-Imidazolium, 3-ethyl-1-methyl-, 4-(1-methylethenyl) benzenesulfonate.

8. The adhesive composition according to claim 1, wherein part b) comprises at least one compound selected from the group consisting of: 1H-Imidazolium, 3-methyl-1-hexyl-4-ethenylbenzenesulfonate; 1H-Imidazolium, 3-ethenyl-1-ethyl-1,1,1-trifluoro-N-[(trifluoromethyl)sulfonyl]methanesulfonamide; and, 1H-Imidazolium, 3-methyl-1-butyl-1,1,1-trifluoro-N-[(trifluoromethyl)sulfonyl]methanesulfonamide.

9. The adhesive composition according to claim 1, wherein part c) comprises at least one azo free radical initiator selected from the group consisting of: azo nitriles; azo esters; azo amides; azo amidines; azo imidazoline; and, macro azo initiators.

10. The adhesive composition according to claim 1, wherein said composition comprises d) solubilizer in an amount up to 10 wt. %, based on the weight of the composition, and said solubilizer is selected from the group consisting of: polyoxyalkylene glycols; silicone surfactants; polyhydric alcohols; and, sugars.

11. The adhesive composition according to claim 1, wherein said composition comprises electrically conductive particles in an amount up to 10 wt. %, based on weight of the composition.

12. The adhesive composition according to claim 11, wherein said electrically conductive particles are selected from the group consisting of silver, carbon black and mixtures thereof.

13. A bonded structure comprising
a first material layer having an electrically conductive surface; and,
a second material layer having an electrically conductive surface;
wherein the curable and electrochemically debondable adhesive composition according to claim 1 is disposed between the first and second material layers.

14. A method of debonding said bonded structure according to claim 13, the method comprising the steps of:
1) applying a voltage across both surfaces to form an anodic interface and a cathodic interface; and
2) debonding the surfaces.

15. A method according to the claim 14, wherein the voltage applied in step 1 is from 0.5 to 200 V and it is applied for a duration of from 1 second to 30 minutes.
